(19) United States
(12) Patent Application Publication
(10) Pub. No.: US 2010/0042669 A1
(43) Pub. Date: Feb. 18, 2010

(54) System and method for modifying illusory user identification characteristics

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William H. Mangione-Smith, Kirkland, WA (US); John D. Rinaldo, JR., Bellevue, WA (US); Clarence T. Tegreene, Bellevue, WA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the State of Delaware

(21) Appl. No.: 12/454,113

(22) Filed: May 12, 2009

Related U.S. Application Data
(63) Continuation-in-part of application No. 12/228,664, filed on Aug. 14, 2008.
Application No. 12/228,664 is a continuation-in-part of application No. 12/228,873, filed on Aug. 15, 2008.
Application No. 12/228,873 is a continuation-in-part of application No. 12/287,268, filed on Oct. 7, 2008.

(51) Int. Cl. G06F 15/16

(52) U.S. Cl. 709/201

(57) ABSTRACT

Methods and systems for modifying illusory user identification characteristics are provided.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 12/228,664, entitled System and Method for Transmitting Illusory Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Aug. 14, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/228,873, entitled System and Method for Transmitting Illusory and Non-Illusory Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Aug. 15, 2008, which is currently co-pending, or is an application of which a currently co-pending application is entitled to the benefit of the filing date.

For purposes of the USPTO extra-statutory requirements, the present application constitutes a continuation-in-part of the application having the U. S. patent application Ser. No. 12/287,268, entitled System and Method for Transmitting Illusory Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Oct. 7, 2008, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

Methods and systems for modifying illusory user identification characteristics are provided.

In one aspect, a method includes but is not limited to: transmitting one or more illusory user identification characteristics associated with one or more users to one or more recipients; and receiving one or more requests from one or more users to modify the one or more illusory user identification characteristics associated with the one or more users. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes but is not limited to: means for transmitting one or more illusory user identification characteristics associated with one or more users to one or more recipients; and means for receiving one or more requests from one or more users to modify the one or more illusory user identification characteristics associated with the one or more users. In addition to the foregoing, other system aspects are described in the claims, drawings, and text forming a part of the present disclosure.

In another aspect, a system includes, but is not limited to: circuitry for transmitting one or more illusory user identification characteristics associated with one or more users to one or more recipients; and circuitry for receiving one or more requests from one or more users to modify the one or more illusory user identification characteristics associated with the one or more users.

In another aspect, a computer program product includes, but is not limited to: a signal-bearing medium bearing: one or more instructions for transmitting one or more illusory user identification characteristics associated with one or more users to one or more recipients; and one or more instructions for receiving one or more requests from one or more users to modify the one or more illusory user identification characteristics associated with the one or more users.

In another aspect, a system includes, but is not limited to: a computing device; and instructions that when executed on the computing device cause the computing device to: transmit one or more illusory user identification characteristics associated with one or more users to one or more recipients; and receive one or more requests from one or more users to modify the one or more illusory user identification characteristics associated with the one or more users.

In one aspect, a method includes but is not limited to: receiving one or more requests from one or more users to modify one or more illusory user identification characteristics associated with one or more users; and modifying one or more illusory user identification characteristics associated with the one or more users. In addition to the foregoing, other method aspects are described in the claims, drawings, and text forming a part of the present disclosure.

In one or more various aspects, related systems include, but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes but is not limited to: means for receiving one or more requests from one or more users to modify one or more illusory user identification characteristics associated with one or more users; and means for modifying one or more illusory user identification characteristics associated with the one or more users. In addition to the foregoing, other system aspects are described in the claims, drawings, and text forming a part of the present disclosure.

In another aspect, a system may include, but is not limited to: circuitry for receiving one or more requests from one or more users to modify one or more illusory user identification characteristics associated with one or more users; and circuitry for modifying one or more illusory user identification characteristics associated with the one or more users.

In another aspect, a computer program product includes, but is not limited to: a signal-bearing medium bearing including: one or more instructions for receiving one or more requests from one or more users to modify one or more illusory user identification characteristics associated with one or more users; and one or more instructions for modifying one or more illusory user identification characteristics associated with the one or more users.

In another aspect, a system may include: a computing device; and instructions that when executed on the computing device cause the computing device to: receive one or more requests from one or more users to modify one or more illusory user identification characteristics associated with one or more users; and modify one or more illusory user identification characteristics associated with the one or more users.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF FIGURES

Figure No.:

FIG. 1 shows a high-level block diagram of a system for modifying illusory user identification characteristics.

FIG. 2 is a high-level logic flowchart of a process.

FIG. 3 is a high-level logic flowchart of a process.

FIG. 4 is a high-level logic flowchart of a process.

FIG. 5 is a high-level logic flowchart of a process.

FIG. 6 is a high-level logic flowchart of a process.

FIG. 7 is a high-level logic flowchart of a process.

FIG. 8 is a high-level logic flowchart of a process.

FIG. 9 is a high-level logic flowchart of a process.

FIG. 10 is a high-level logic flowchart of a process.

FIG. 11 is a high-level logic flowchart of a process.

FIG. 12 is a high-level logic flowchart of a process.

FIG. 13 is a high-level logic flowchart of a process.

FIG. 14 is a high-level logic flowchart of a process.

FIG. 15 is a high-level logic flowchart of a process.

FIG. 16 is a high-level logic flowchart of a process.

FIG. 17 is a high-level logic flowchart of a process.

FIG. 18 is a high-level logic flowchart of a process.

FIG. 19 is a high-level logic flowchart of a process.

FIG. 20 shows a high-level block diagram of a computer program product.

FIG. 21 shows a high-level block diagram of a system for modifying illusory user identification characteristics.

FIG. 22 is a high-level logic flowchart of a process.

FIG. 23 is a high-level logic flowchart of a process.

FIG. 24 is a high-level logic flowchart of a process.

FIG. 25 is a high-level logic flowchart of a process.

FIG. 26 is a high-level logic flowchart of a process.

FIG. 27 is a high-level logic flowchart of a process.

FIG. 28 is a high-level logic flowchart of a process.

FIG. 29 is a high-level logic flowchart of a process.

FIG. 30 is a high-level logic flowchart of a process.

FIG. 31 is a high-level logic flowchart of a process.

FIG. 32 is a high-level logic flowchart of a process.

FIG. 33 is a high-level logic flowchart of a process.

FIG. 34 is a high-level logic flowchart of a process.

FIG. 35 is a high-level logic flowchart of a process.

FIG. 36 is a high-level logic flowchart of a process.

FIG. 37 is a high-level logic flowchart of a process.

FIG. 38 shows a high-level block diagram of a computer program product.

FIG. 39 shows a high-level block diagram of a system for modifying illusory user identification characteristics.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

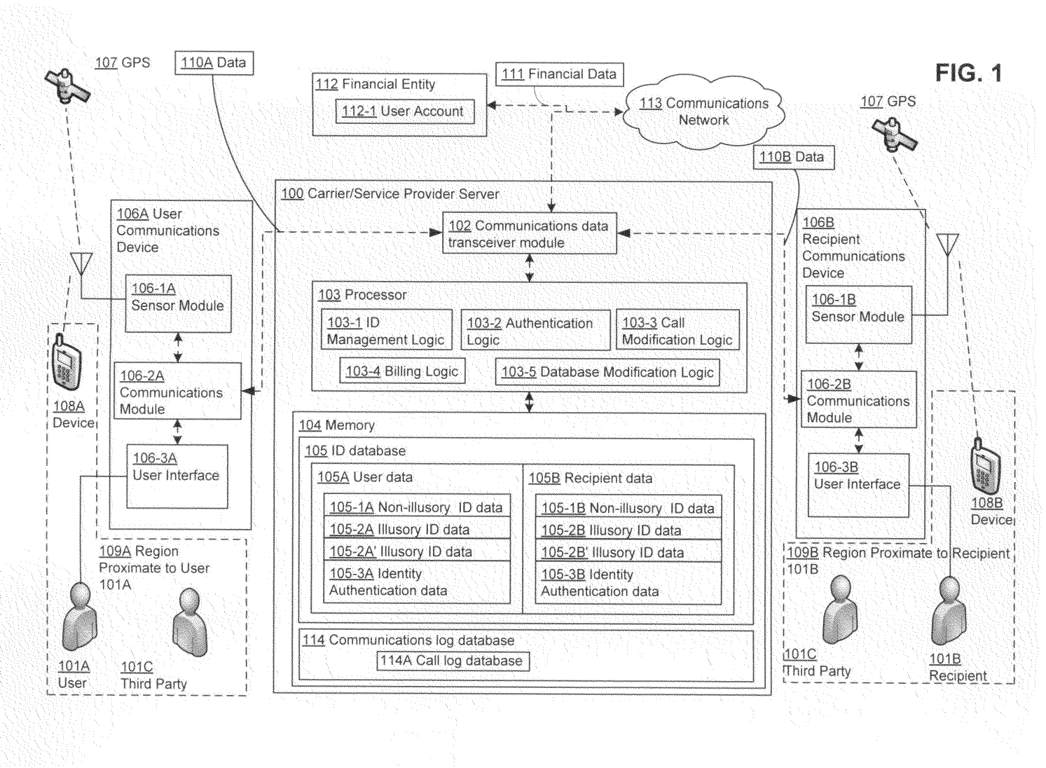

FIG. 1 illustrates an example environment in which one or more technologies may be implemented. A system for providing illusory user identification characteristics may include a carrier/service provider server 100, a user communications device 106A and a recipient communications device 106B. The user communications device 106A and recipient communications device 106B may be associated with the user 101A (e.g. an entity employing the system to provide one or more illusory user identification characteristics to a recipient) and a recipient 101B (e.g. an entity receiving one or more illusory user identification characteristics), respectively. The association of the user communications device 106A and recipient communications device 106B with the user 101A and the recipient 101B, respectively, may include subscription-based communication services for user 101A and recipient 101B that may be activated on user communications device 106A and recipient communications device 106B, respectively.

Although the user 101A and recipient 101B may be shown/described herein as a single illustrated figure, those skilled in the art will appreciate that the user 101A and recipient 101B may be representative of a human user, a robotic user (e.g., computational entity), and/or substantially any combination thereof (e.g., a user may be assisted by one or more robotic agents). The user 101A and/or the recipient 101B may include, but are not limited to, a voicemail service, a text messaging service, a web-based application service, and the like.

The carrier/service provider server 100 may be an integrated or distributed server system associated with one or more communication networks 113. Numerous types of communication networks 113 may be used. Examples of a communication network 113 may include, but are not limited to, a voice over internet protocol (VoIP) network (e.g. networks maintained by Vonage®, Verizon®, Sprint®), a cellular network (e.g. networks maintained by Verizon®, Sprint®, AT&T®, T-Mobile®), a text messaging network (e.g. an SMS system in GSM), and an e-mail system (e.g. an IMAP, POP3, SMTP, and/or HTTP e-mail server), and the like.

The carrier/service provider server 100 may include a communications data transceiver module 102. Numerous types of communications data transceiver modules 102 may be used. Examples of communications data transceiver modules 102 may include, but are not limited to, a cellular transceiver, a satellite transceiver and a network portal (e.g. a modem linked to an internet service provider).

The carrier/service provider server 100 may include a processor 103. Numerous types of processors 103 may be used (e.g. general purpose processors such those marketed by Intel® and AMD, application specific integrated circuits, and the like). For example, the processor 103 may include, but is not limited to, one or more logic blocks capable of performing one or more computational functions, such as ID management logic 103-1, authentication logic 103-2, call modification logic 103-3, billing logic 103-4 and/or database modification logic 103-5.

The carrier/service provider server 100 may include a memory 104. Numerous types of memory 104 may be used (e.g. RAM, ROM, flash memory, and the like). The memory 104 may include, but is not limited to, an ID database 105 including ID data for one or more users (e.g. user data 105A associated with the user 101A and recipient data 105B associated with the recipient 101B). An ID database item may include one or more fields including identity data. For example, the user data 105A may include non-illusory ID data 105-1A, one or more illusory ID data (e.g. illusory ID data 105-2A, 105-2A′, etc.), and/or identity authentication data 105-3A. Non-illusory ID data may include one or more non-illusory user identification characteristics (e.g. a characteristic which corresponds to an actual characteristic of user 101A). Illusory ID data may include one or more illusory user identification characteristics (e.g. a characteristic which does not correspond to an actual characteristic of user 101A).

The recipient data 105B may include non-illusory ID data 105-1B, one or more illusory ID data (e.g. illusory ID data 105B, 105-2B′, etc.), and/or identity authentication data 105-3B. The non-illusory ID data 105-1B may include one or more non-illusory user identification characteristics (e.g. a characteristic which corresponds to an actual characteristic of recipient 101B). The illusory ID data 105 may include one or more illusory user identification characteristics (e.g. a characteristic which does not correspond to an actual characteristic of recipient 101B).

The user data 105A and/or the recipient data 105B may include data representing various identification characteristics of one or more users (e.g. user 101A and/or recipient 101B). The identification characteristics of the one or more users may include, but are not limited to, user names, identification numbers, telephone numbers (and/or area codes, international codes, and the like), images, voice prints, locations, ages, sex, gender, physical trait, and the like. Such identification characteristics may be illusory (e.g. the identification characteristic includes one or more fictitious elements with respect to attributes of user 101A or recipient 101B) or non-illusory (e.g. the identification characteristic accurately reflects attributes of the user 101A or recipient 101B).

The user 101A and the recipient 101B may communicate using user communications device 106A and recipient communications device 106B, respectively. Numerous communications devices may be used. For example, the user communications device 106A and recipient communications device 106B may include, but are not limited to, a cell phone, satellite phone, Blackberry®, landline phone, a VoIP enabled device and/or computing device (e.g. a desktop or laptop computer).

The user communications device 106A and recipient communications device 106B may include a sensor module 106-1 (e.g. sensor module 106-1A and sensor module 106-1B respectively). Numerous sensor modules may be used. For example, the sensor module 106-1A and/or sensor module 106-1B may include, but are not limited to, one or more of an image capture device (e.g. a digital camera), a microphone, a global positioning system (GPS) transceiver, an electromagnetic radiation transceiver and/or a biometric sensor (e.g. a voice recognition sensor, a retinal scanner and/or a fingerprint scanner).

The user communications device 106A and recipient communications device 106B may include a communications module 106-2 (e.g. communications module 106-2A and communications module 106-2B, respectively). Numerous communications modules may be used. For example, the communications module 106-2A and/or the communications module 106-2B may include, but are not limited to, one or more of a cellular transceiver, a Bluetooth transceiver, a Wi-Fi transceiver, a satellite transceiver and a network port (e.g. a modem).

The user communications device 106A and recipient communications device 106B may include a user interface 106-3 (e.g. user interface 106-3A and user interface 106-3B, respectively). Numerous user interfaces may be used. For example, the user interface 106-3A and/or user interface 106-3B may include, but are not limited to, one or more of a display screen, a touch screen, a keypad, a speaker system, a microphone, a camera, and the like.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

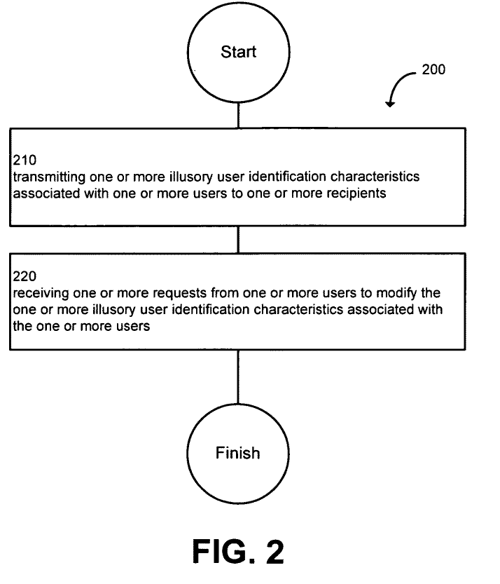

FIG. 2 illustrates an operational flow 200 representing example operations related to transmitting illusory user identification characteristics. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those that are illustrated, or may be performed concurrently.

After a start operation, the operational flow 200 moves to an operation 210. Operation 210 depicts transmitting one or more illusory user identification characteristics associated with one or more users to one or more recipients. For example, as shown in FIG. 1, the communications data transceiver module 102 of the carrier/service provider server 100 may transmit data 110B including illusory ID data 105-2A associated with user 101A to a recipient communications device 106B associated with a recipient 101B. The illusory ID data 105-2A may be received by a communications module 106-2B of the recipient communications device 106B and presented to the recipient 101B via the user interface 106-3B of the recipient communications device 106B. The communications data transceiver module 102 may transmit data 110B in any number of communications data formats including, but not limited to a voice call (e.g. a landline or wireless phone call), a text message, an instant message, an e-mail or a VoIP call.

The operation 220 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104.

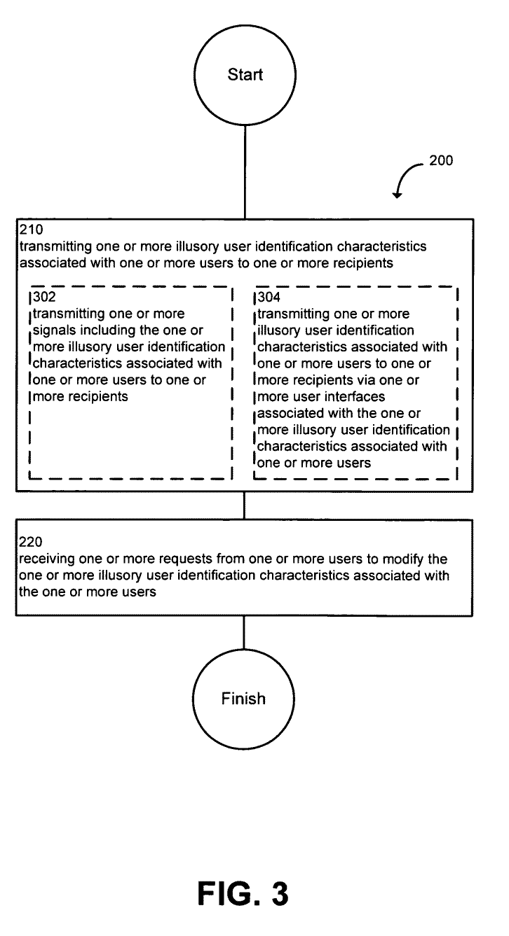

FIG. 3 illustrates alternative embodiments of the example operational flow 200 of FIG. 2. FIG. 3 illustrates example embodiments where the transmitting operation 210 may include at least one additional operation. Additional operations may include an operation 302 and/or an operation 304.

The operation 302 illustrates transmitting one or more signals including the one or more illusory user identification characteristics associated with one or more users to one or more recipients. For example, as shown in FIG. 1, the communications data transceiver module 102 of the carrier/service provider server 100 may transmit data 110B including signals (e.g. electrical signals, radio frequency signals, and the like) including illusory ID data 105-2A associated with user 101A to a recipient communications device 106B associated with recipient 101B. The signals including the illusory ID data 105-2A may be received by a communications module 106-2B of the recipient communications device 106B and presented to the recipient 101B as one or more sounds, images, and the like, via the user interface 106-3B of the recipient communications device 106B. The communications data transceiver module 102 may transmit signal data 110B for any number of communication purposes including, but not limited to voice calls (e.g. a landline or wireless phone call), a text messages, an e-mails or a VoIP calls.

The operation 304 illustrates transmitting one or more illusory user identification characteristics associated with one or more users to one or more recipients via one or more user interfaces associated with the one or more illusory user identification characteristics associated with one or more users. For example, as shown in FIG. 1, the communications data transceiver module 102 of the carrier/service provider server 100 may transmit data 110B including illusory ID data 105-2A associated with user 101A to a recipient communications device 106B associated with recipient 101B. The data 110B may further include user interface instructions which may cause recipient communications device 106B to present a particular user interface 106-3B to recipient 101B according to the illusory ID data 105-2A. The user interface 106-3B may include various displayed images and/or tones, user input options, and the like, which are associated with illusory ID data 105-2A. For example, when illusory ID data 105-2A is transmitted to recipient 101B, a password prompt may be provided to the recipient 101B. Alternately, when illusory ID data 105-2A′ is transmitted to recipient 101B, no prompt may be provided to the recipient 101B.

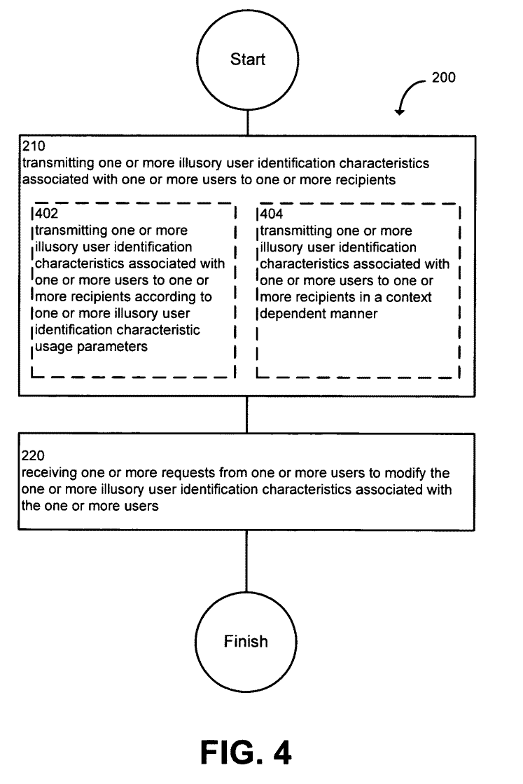

FIG. 4 illustrates alternative embodiments of the example operational flow 200 of FIG. 2. FIG. 4 illustrates example embodiments where the transmitting operation 210 may include at least one additional operation. Additional operations may include an operation 402 and/or an operation 404.

The operation 402 illustrates transmitting one or more illusory user identification characteristics associated with one or more users to one or more recipients according to one or more illusory user identification characteristic usage parameters. For example, as shown in FIG. 1, the communications data transceiver module 102 of the carrier/service provider server 100 may transmit data 110B including illusory ID data 105-2A associated with user 101A to a recipient communications device 106B associated with recipient 101B according to an illusory user identification characteristic usage parameter (e.g. a location parameter, a time parameter, a proximity parameter). An illusory user identification characteristic usage parameter may control the manner in which the illusory ID data 105-2A is provided to recipient 101B (e.g. the illusory ID data 105-2A may only be transmitted to recipient 101B at certain times of the day while non-illusory ID data 105-1 may be transmitted to recipient 101B at other times of the day).

The operation 404 illustrates transmitting one or more illusory user identification characteristics associated with one or more users to one or more recipients in a context dependent manner. For example, as shown in FIG. 1, the communications data transceiver module 102 of the carrier/service provider server 100 may transmit data 110B including illusory ID data 105-2A associated with user 101A to a recipient communications device 106B associated with recipient 101B according to a context (e.g. a location of user 101A, a location of the recipient 101B, a proximity of a third party 101C to user 101A and/or the recipient 101B, and the like) of the user 101A.

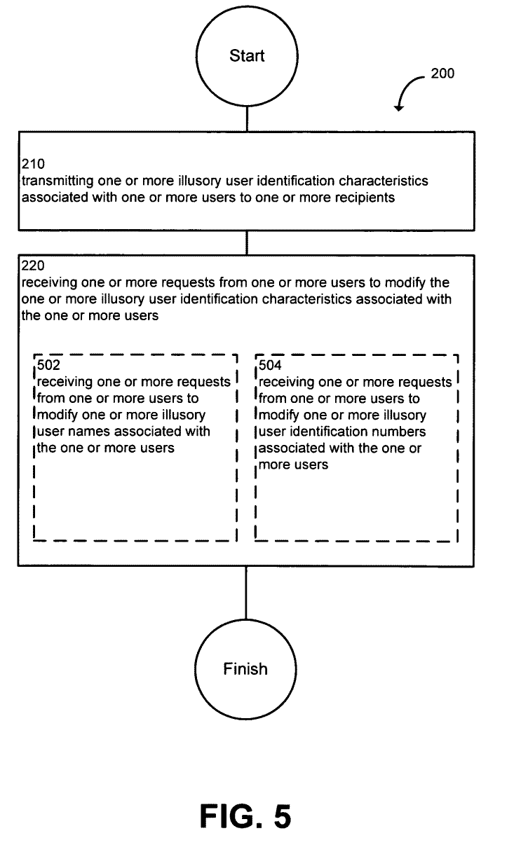

FIG. 5 illustrates alternative embodiments of the example operational flow 200 of FIG. 2. FIG. 5 illustrates example embodiments where the receiving operation 220 may include at least one additional operation. Additional operations may include an operation 502 and/or an operation 504.

The operation 502 illustrates receiving one or more requests from one or more users to modify one or more illusory user names associated with the one or more users. For example, as shown in FIG. 1, the carrier/service provider server 100 may receive a request from the user 101A to modify an illusory user name maintained as illusory ID data 105-2A associated with user 101A. A request to modify an associated illusory user identification name may be inputted by user 101A via user interface 106-3A of user communications device 106A and transmitted as part of data 110A from the user communications device 106A and received by the communications data transceiver module 102 of the carrier/service provider server 100.

The operation 504 illustrates receiving one or more requests from one or more users to modify one or more illusory user identification numbers associated with the one or more users. For example, as shown in FIG. 1, the carrier/service provider server 100 may receive a request from the user 101A to modify an illusory user identification number (e.g. a social security number) maintained as illusory ID data 105-2A associated with user 101A. A request to modify an associated illusory user identification number may be inputted by user 101A via user interface 106-3A of user communications device 106A and transmitted as part of data 110A from the user communications device 106A and received by the communications data transceiver module 102 of the carrier/service provider server 100.

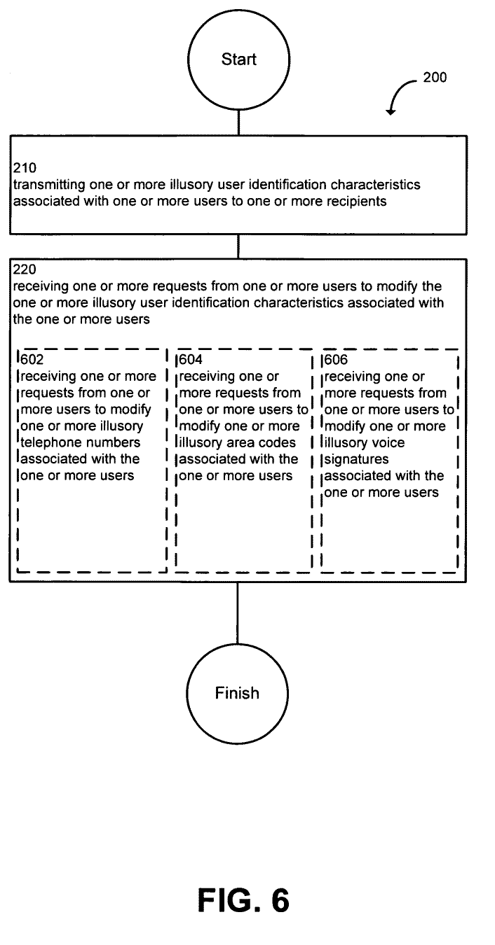

FIG. 6 illustrates alternative embodiments of the example operational flow 200 of FIG. 2. FIG. 6 illustrates example embodiments where the receiving operation 220 may include at least one additional operation. Additional operations may include an operation 602, an operation 604 and/or an operation 606.

The operation 602 illustrates receiving one or more requests from one or more users to modify one or more illusory telephone numbers associated with the one or more users. For example, as shown in FIG. 1, the carrier/service provider server 100 may receive a request from the user 101A to modify an illusory user telephone number maintained as illusory ID data 105-2A associated with user 101A. A request to modify an associated illusory user telephone number may be inputted by user 101A via user interface 106-3A of user communications device 106A and transmitted as part of data 110A from the user communications device 106A and received by the communications data transceiver module 102 of the carrier/service provider server 100.

The operation 604 illustrates receiving one or more requests from one or more users to modify one or more illusory area codes associated with the one or more users. For example, as shown in FIG. 1, the carrier/service provider server 100 may receive a request from the user 101A to modify an illusory user area code (e.g. an international dialing code, country codes, city codes, cell phone codes, NANPA codes, ITU-T code, a code established under the North American Numbering Plan, and the like) maintained as illusory ID data 105-2A associated with user 101A. A request to modify an associated illusory user area code may be inputted by user 101A via user interface 106-3A of user communications device 106A and transmitted as part of data 110A transmitted from the user communications device 106A and received by the communications data transceiver module 102 of the carrier/service provider server 100.

The operation 606 illustrates receiving one or more requests from one or more users to modify one or more illusory voice signatures associated with the one or more users. For example, as shown in FIG. 1, the carrier/service provider server 100 may receive a request from the user 101A to modify an illusory user voice signature (e.g. altering a pitch, tone, volume and/or tempo of a voice signature relative to an actual voice signature of user 101A) maintained as illusory ID data 105-2A associated with user 101A. A request to modify an associated illusory user voice signature may be inputted by user 101A via user interface 106-3A of user communications device 106A and transmitted as part of data 110A from the user communications device 106A and received by the communications data transceiver module 102 of the carrier/service provider server 100.

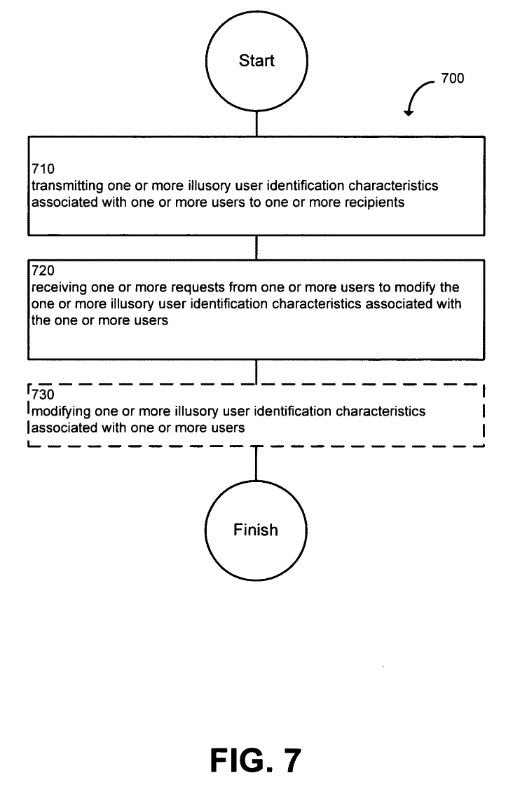

FIG. 7 illustrates an operational flow 700 representing example operations related to transmitting illusory user identification characteristics. Operations 710 and 720 of operational flow 700 may be similar to those of operations 210 and 220 respectively, as described above with respect to operational flow 200. Operational flow 700 may include one or more additional operations. Additional operations may include an operation 730.

Operation 710 depicts transmitting one or more illusory user identification characteristics associated with one or more users to one or more recipients. For example, as shown in FIG. 1, the communications data transceiver module 102 of the carrier/service provider server 100 may transmit data 110B including illusory ID data 105-2A associated with user 101A to a recipient communications device 106B associated with a recipient 101B. The illusory ID data 105-2A may be received by a communications module 106-2B of the recipient communications device 106B and presented to the recipient 101B via the user interface 106-3B of the recipient communications device 106B. The communications data transceiver module 102 may transmit data 110B in any number of communications data formats including, but not limited to a voice call (e.g. a landline or wireless phone call), a text message, an instant message, an e-mail or a VoIP call.

The operation 720 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104.

The operation 730 illustrates modifying one or more illusory user identification characteristics associated with the one or more users. For example, as shown in FIG. 1, the communications data transceiver module 102 of carrier/service provider server 100 may receive a request from user 101A to modify the ID database 105 (e.g. a request to alter a user name, image, voice signature, and the like). The database modification logic 103-5 of the carrier/service provider server 100 may modify the user data 105A, recipient data 105B, or user data 105A and recipient data 105B as requested by the user 101A by overwriting and/or remapping the user data 105A, recipient data 105B, or user data 105A and recipient data 105B to correspond to data representing the modified user characteristic (e.g. an updated voice signature having a lower pitch than the actual voice signature of user 101A).

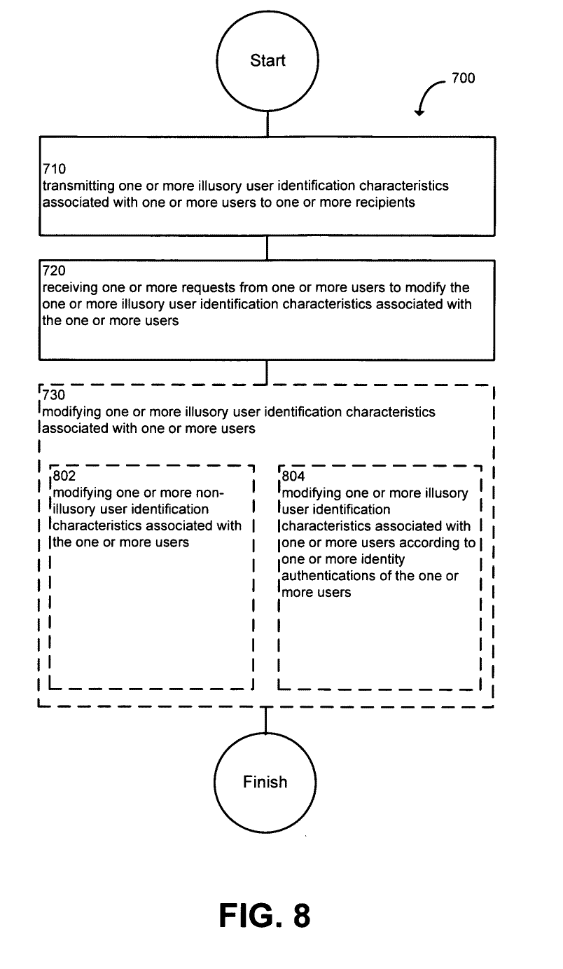

FIG. 8 illustrates alternative embodiments of the example operational flow 700 of FIG. 7. FIG. 8 illustrates example embodiments where the modifying operation 730 of FIG. 7 may include at least one additional operation. Additional operations may include an operation 802, and/or an operation 804.

The operation 802 illustrates modifying one or more non-illusory user identification characteristics associated with the one or more users. For example, as shown in FIG. 1, the communications data transceiver module 102 of carrier/service provider server 100 may receive a request from the user 101A to modify the ID database 105 including non-illusory ID data 105-1A maintained in memory 104. The database modification logic 103-5 of the carrier/service provider server 100 may modify the user data 105A, recipient data 105B, or user data 105A and recipient data 105B as requested by the user 101A by overwriting and/or remapping the non-illusory ID data 105-1A to correspond to data representing a desired user characteristic (e.g. an updated non-illusory image).

The operation 804 illustrates modifying one or more illusory user identification characteristics associated with the one or more users according to one or more identity authentications of the one or more users. For example, as shown in FIG. 1, the carrier/service provider server 100 may receive identity authentication data 110A (e.g. a password identity authentication, a biometric identity authentication, and the like) from the user 101A which contains certain information specific to the user 101A so as to verify that only an authorized user 101A may modify the ID database 105. The authentication logic 103-2 may receive the identity authentication data 110A and compare it to identity authentication data 105-3A associated with user 101A. Upon verification that identity authentication data 110A (e.g. password data, biometric data, and the like) received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

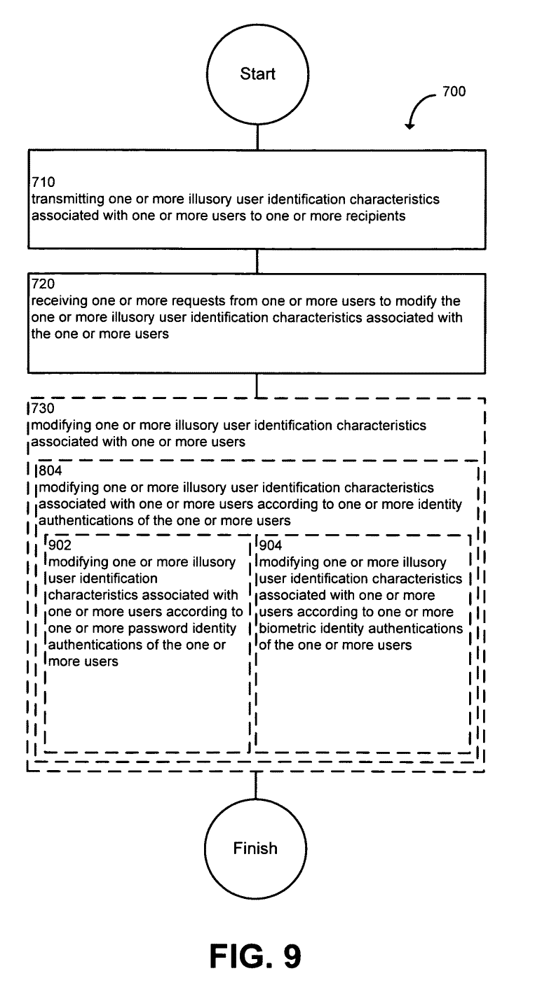

FIG. 9 illustrates alternative embodiments of the example operational flow 700 of FIG. 8. FIG. 9 illustrates example embodiments where the modifying operation 804 of FIG. 8 may include at least one additional operation. Additional operations may include an operation 902, and/or an operation 904.

The operation 902 illustrates modifying one or more illusory user identification characteristics associated with the one or more users according to one or more password identity authentications of the one or more users. For example, as shown in FIG. 1, the user 101A may provide an input through a user interface 106-3A of user communications device 106A whereby the user 101A transmits a password in the form of password data 110A to the carrier/service provider server 100. The carrier/service provider server 100 may receive the password identity authentication data 110A from the user 101A which contains a password specific to user 101A so as to verify that only an authorized user is attempting to modify the ID database 105. The authentication logic 103-2 may receive the password identity authentication data 110A and compare it to identity authentication data 105-3A associated with user 101A. Upon verification that the password identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 904 illustrates modifying one or more illusory user identification characteristics associated with one or more users according to one or more biometric identity authentications of the one or more users. For example, as shown in FIG. 1, the user 101A may provide an input through a user interface 106-3A of user communications device 106A whereby the user 101A transmits a biometric identity authentication (e.g. DNA sampling, facial recognition, facial thermograph, eye scans, hand/vein geometry, scent analysis and the like) in the form of biometric identity authentication data 110A to the carrier/service provider server 100. The carrier/service provider server 100 may receive the biometric identity authentication data 110A from the user 101A which contains biometric data specific to that user so as to verify that only an authorized user is attempting to modify the ID database 105. The authentication logic 103-2 may receive the biometric identity authentication data 110A and compare it to identity authentication data 105-3A associated with user 101A. Upon verification that the biometric identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

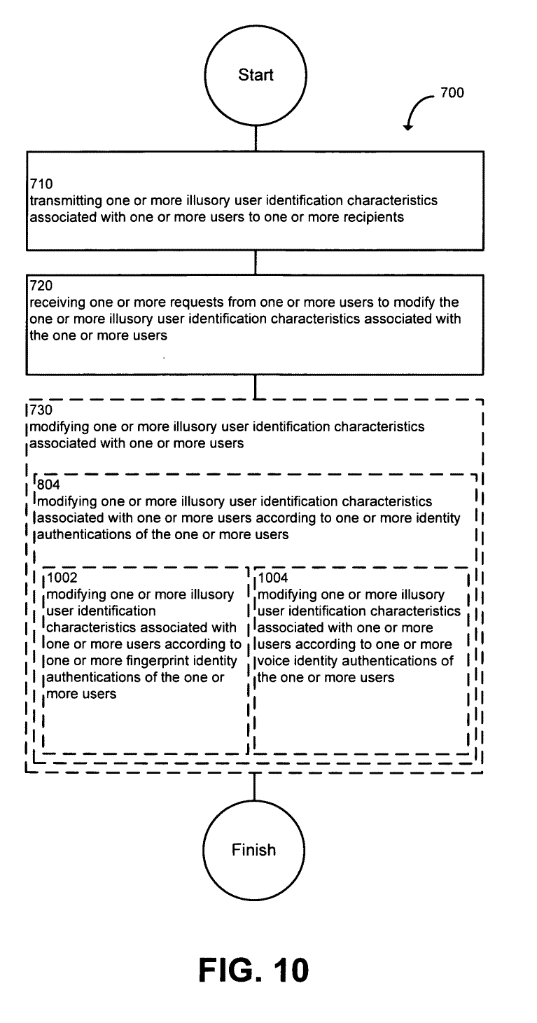

FIG. 10 illustrates alternative embodiments of the example operational flow 700 of FIG. 8. FIG. 10 illustrates example embodiments where the modifying operation 804 may include at least one additional operation. Additional operations may include an operation 1002 and/or an operation 1004.

The operation 1002 illustrates modifying one or more illusory user identification characteristics associated with one or more users according to one or more fingerprint identity authentications of the one or more users. For example, as shown in FIG. 1, the user 101A may provide an input through a user interface 106-3A (e.g. a fingerprint scanner) of user communications device 106A whereby the user 101A transmits a fingerprint identity authentication in the form of fingerprint identity authentication data 110A to the carrier/service provider server 100. The carrier/service provider server 100 may receive the fingerprint identity authentication data 110A from the user 101A which contains fingerprint data specific to user 101A so as to verify that only an authorized user is attempting to modify the ID database 105. The authentication logic 103-2 may receive the fingerprint identity authentication data 110A and compare it to identity authentication data 105-3A associated with user 101A. Upon verification that the fingerprint identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 1004 illustrates modifying one or more illusory user identification characteristics associated with one or more users according to one or more voice identity authentications of the one or more users. For example, as shown in FIG. 1, the user 101A may provide an input through a user interface 106-3A (e.g. a microphone operably coupled to voice recognition circuitry) of user communications device 106A whereby the user 101A transmits a voice identity authentication in the form of voice identity authentication data 110A to the carrier/service provider server 100. The carrier/service provider server 100 may receive the voice identity authentication data 110A from the user 101A which contains voice data specific to user 101A so as to verify that only an authorized user is attempting to modify the ID database 105. The authentication logic 103-2 may receive the voice identity authentication data 110A and compare it to identity authentication data 105-3A associated with user 101A. Upon verification that the voice identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

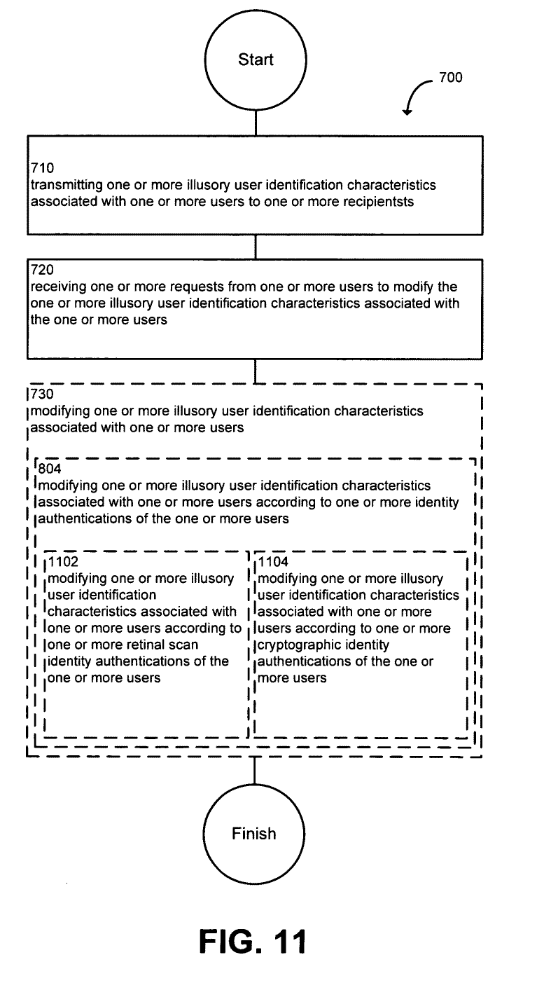

FIG. 11 illustrates alternative embodiments of the example operational flow 700 of FIG. 8. FIG. 11 illustrates example embodiments where the modifying operation 804 may include at least one additional operation. Additional operations may include an operation 1102 and/or an operation 1104.

The operation 1102 illustrates modifying one or more illusory user identification characteristics associated with one or more users according to one or more retinal scan identity authentications of the one or more users. For example, as shown in FIG. 1, the user 101A may provide an input through a user interface 106-3A (e.g. a retinal scanner) of user communications device 106A whereby the user 101A transmits a retinal scan identity authentication in the form of retinal scan identity authentication data 110A to the carrier/service provider server 100. The carrier/service provider server 100 may receive the retinal scan identity authentication data 110A from the user 101A which contains retinal scan data specific to that user so as to verify that only an authorized user is attempting to modify the ID database 105. The authentication logic 103-2 may receive the retinal scan identity authentication data 110A and compare it to identity authentication data 105-3A associated with user 101A. Upon verification that the retinal scan identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 1104 illustrates modifying one or more illusory user identification characteristics associated with one or more users according to one or more cryptographic identity authentications of the one or more users. For example, as shown in FIG. 1, the user 101A may provide an input (e.g. a key associated with a cipher implemented by the communications data transceiver module 102 and/or the user communications device 106A) through a user interface 106-3A (e.g. a keypad) of user communications device 106A whereby the user 101A transmits a cryptographic identity authentication in the form of cryptographic identity authentication data 110A to the carrier/service provider server 100. The carrier/service provider server 100 may receive the cryptographic identity authentication data 110A from the user 101A which contains cryptographic data specific to that user so as to verify that only an authorized user is attempting to modify the ID database 105. The authentication logic 103-2 may receive the cryptographic identity authentication data 110A and compare it to identity authentication data 105-3A associated with user 101A. Upon verification that the cryptographic identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

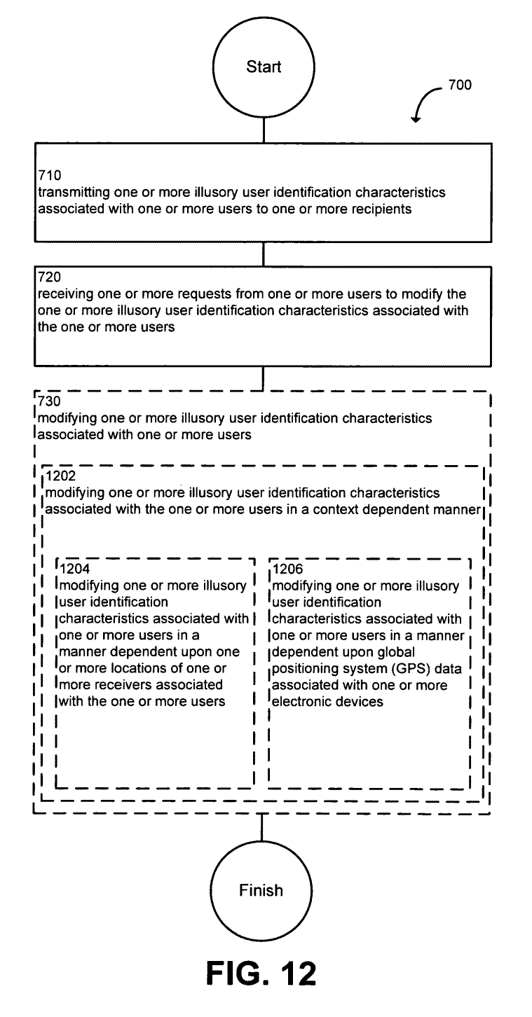

FIG. 12 illustrates alternative embodiments of the example operational flow 700 of FIG. 7. FIG. 12 illustrates example embodiments where the modifying operation 730 may include at least one additional operation. Additional operations may include an operation 1202.

The operation 1202 illustrates modifying one or more illusory user identification characteristics associated with the one or more users in a context dependent manner. For example, as shown in FIG. 1, the database modification logic 103-5 of the carrier/service provider server 100 may modify user data 105A as requested by the user 101A according to a context (e.g. a location of user 101A, a proximity of a third party 101C to user 101A, and the like) of the user 101A. The database modification logic 103-5 may cause the carrier/service provider server 100 to modify user data 105A as requested by the user 101A when the context of user 101A indicates a low likelihood of the presence of a third party 101 C so as to avoid disclosure of the contents of user data 105A.

FIG. 12 further illustrates example embodiments where the modifying operation 1202 may include at least one additional operation. Additional operations may include an operation 1204 and/or an operation 1206.

The operation 1204 illustrates modifying one or more illusory user identification characteristics associated with the one or more users in a manner dependent upon one or more locations of one or more transceivers associated with the one or more users. For example, as shown in FIG. 1, the communications module 106-2A of the user communications device 106A associated with the user 101A may include one or more transceivers (e.g. RF transceivers, optical transceivers, modem transceivers, and the like) for transceiving data 110A from the carrier/service provider server 100. The carrier/service provider server 100 may detect the location of the user communications device 106A through communication with the transceiver of the user communications device 106A. The carrier/service provider server 100 may identify the location by monitoring a geographic indicator (e.g. a cell tower location, e-mail service provider, telephone area code, network IP address, and the like) associated with the transceiver of the user communications device 106A. The database modification logic 103-5 may cause the carrier/service provider server 100 to modify user data 105A as requested by the user 101A according to the location of the one or more transceivers (e.g. modification of the user data 105A by the user 101A may be allowed when the transceiver context data indicates that user 101A is in a private location such as a home or office).

The operation 1206 illustrates modifying one or more illusory user identification characteristics associated with the one or more users in a manner dependent upon global positioning system (GPS) data associated with one or more electronic devices. For example, as shown in FIG. 1, the user communications device 106A associated with user 101A may include a GPS sensor module 106-1A including one or more transceivers for transceiving signals from a GPS satellite 107. GPS data 110A associated with the location of the user communications device 106A may be received by the communications data transceiver module 102 of the carrier/service provider server 100. The database modification logic 103-5 may cause the carrier/service provider server 100 to modify the user data 105A as requested by the user 101A according to the GPS data 110A (e.g. modification of the user data 105A by the user 101A may be allowed when the GPS context data indicates that user 101A is in a private location such as a home or office).

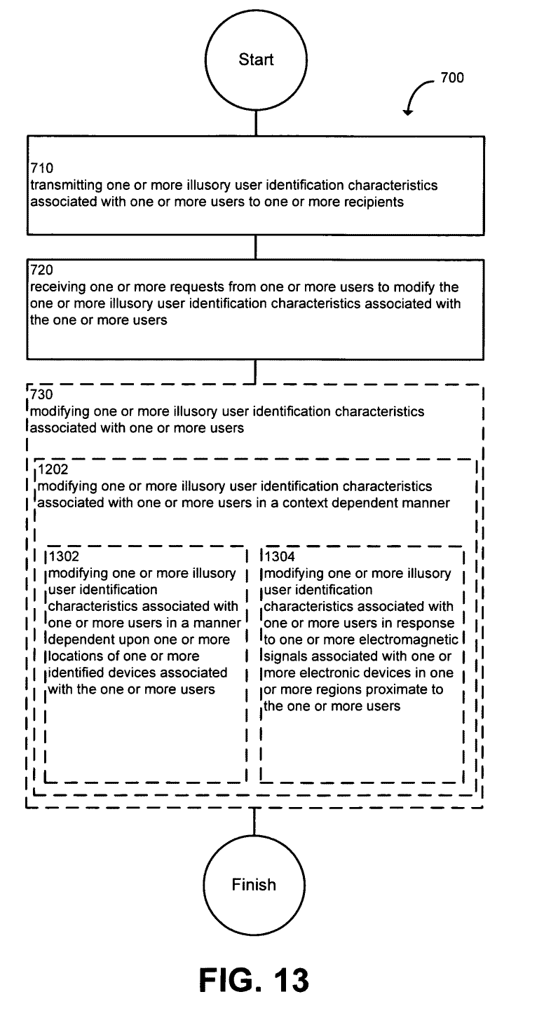

FIG. 13 illustrates alternative embodiments of the example operational flow 700 of FIG. 12. FIG. 13 illustrates example embodiments where the operation 1202 may include at least one additional operation. Additional operations may include an operation 1302 and/or an operation 1304.

The operation 1302 illustrates modifying one or more illusory user identification characteristics associated with the one or more users in a manner dependent upon one or more locations of one or more identified devices associated with the one or more users. For example, as shown in FIG. 1, the carrier/service provider server 100 may detect the location of the user communications device 106A associated with user 101A (e.g. a cell phone, satellite phone, Blackberry®, landline phone, a VoIP enabled device and/or computing device) associated with user 101A through communication with the user communications device 106A. The carrier/service provider server 100 may identify the location by monitoring a geographic indicator (e.g. a cell tower location, e-mail service provider, telephone area code, and the like) associated with the user communications device 106A. The database modification logic 103-5 may cause the carrier/service provider server 100 to modify user data 105A as requested by the user 101A according to the location of the user communications device 106A (e.g. modification of the user data 105A by the user 101A may be allowed when the device context data indicates that user 101A is in a private location such as a home or office).

The operation 1304 illustrates modifying one or more illusory user identification characteristics associated with the one or more users in response to one or more electromagnetic signals associated with one or more electronic devices in one or more regions proximate to the one or more users. For example, as shown in FIG. 1, the user communications device 106A associated with user 101A may include a radio frequency sensor module 106-1A including one or more transceivers for transceiving RF signals (e.g. signals emitted by an electronic device 108A in a region proximate to user 101A (e.g. region 109A). The data 110A associated with the RF environment proximate to the user communications device 106A may be received by the communications data transceiver module 102 of the carrier/service provider server 100. The database modification logic 103-5 may cause the carrier/service provider server 100 to modify the ID database 105 as requested by the user 101A according to the RF data 110A (e.g. modification of the ID database 105 by the user 101A may not be allowed when RF data 110A indicates that user 101A is in proximity to an electronic device 108A while modification of the ID database 105 by the user 101A may be allowed when the RF data 110A indicates that the user 101A is not in proximity to electronic device 108A).

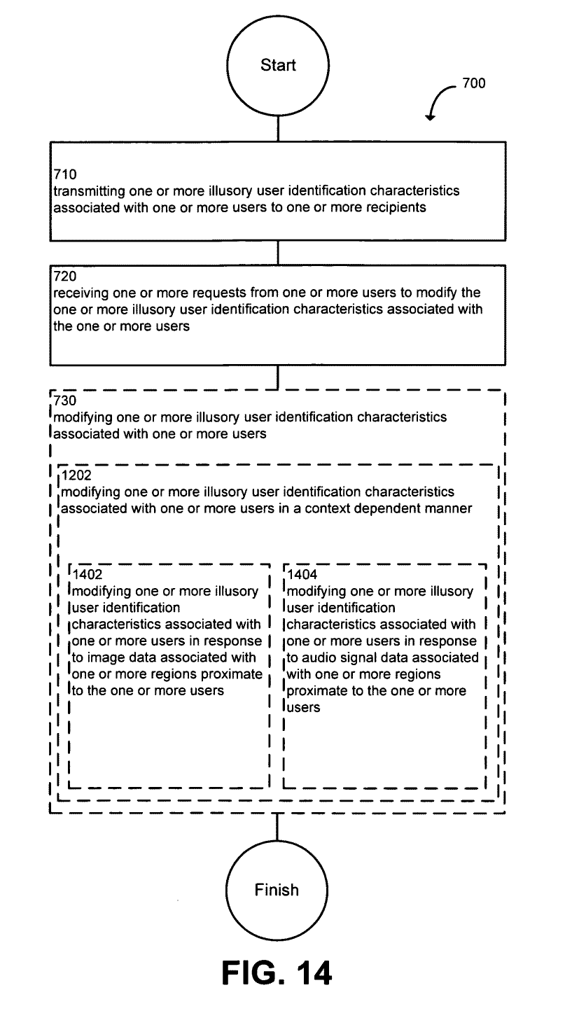

FIG. 14 illustrates alternative embodiments of the example operational flow 700 of FIG. 12. FIG. 14 illustrates example embodiments where the operation 1202 may include at least one additional operation. Additional operations may include an operation 1402 and/or an operation 1404.

The operation 1402 illustrates modifying one or more illusory user identification characteristics associated with the one or more users in response to image data associated with one or more regions proximate to the one or more users. For example, as shown in FIG. 1, the user communications device 106A associated with user 101A may include an image sensor module 106-1A including one or more image capture devices for receiving images (e.g. images of a region proximate to user 101A such as region 109A). The image data 110A associated with the visual environment proximate to the user communications device 106A may be received by the communications data transceiver module 102 of the carrier/service provider server 100. The database modification logic 103-5 employing image recognition logic may cause the carrier/service provider server 100 to modify the ID database 105 as requested by the user 101A according to the image data 110A. Modification of the ID database 105 by the user 101A may be restricted when image data 110A indicates that the user 101A may be in proximity to a third party 101C (e.g. image recognition logic detects an image of a home, office, identified person, and the like) while modification of the ID database 105 by the user 101A may be allowed when image data 110A indicates that user 101A is not in proximity to third party 101C.

The operation 1404 illustrates modifying one or more illusory user identification characteristics associated with the one or more users in response to audio signal data associated with one or more regions proximate to the one or more users. For example, as shown in FIG. 1, the user communications device 106A associated with user 101A may include an audio sensor module 106-1A (e.g. one or more microphones) for receiving audio signals (e.g. sounds emitted in a region proximate to user 101A such as region 109A). The data 110A associated with the audio environment proximate to the of the user communications device 106A may be received by the communications data transceiver module 102 of the carrier/service provider server 100. The database modification logic 103-5 employing audio recognition logic may cause the carrier/service provider server 100 to modify the ID database 105 as requested by the user 101A according to the audio data 110A. Modification of the ID database 105 by the user 101A may be restricted when audio data 110A indicates that the user 101A may be in proximity to a third party 101C (e.g. audio recognition logic detects sounds indicative of a home, an office, a person having an identified voice print, and the like) while modification of the ID database 105 by the user 101A may be allowed when audio data 110A indicates that user 101A is not in proximity to third party 101C.

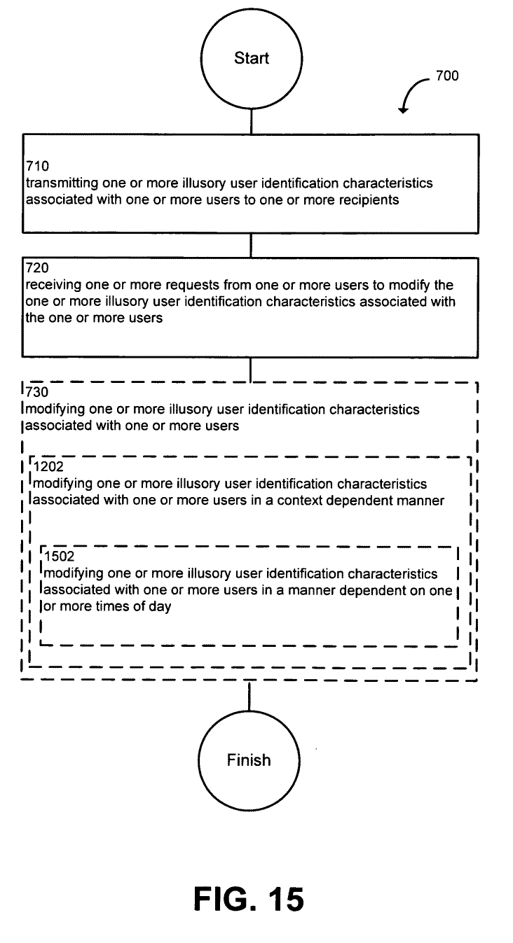

FIG. 15 illustrates alternative embodiments of the example operational flow 700 of FIG. 12. FIG. 15 illustrates example embodiments where the operation 1202 may include at least one additional operation. Additional operations may include an operation 1502.

The operation 1502 illustrates modifying one or more illusory user identification characteristics associated with the one or more users in a manner dependent on one or more times of day. For example, as shown in FIG. 1, the database modification logic 103-5 may maintain internal clock logic and may cause the communications data transceiver module 102 of the carrier/service provider server 100 to modify the ID database 105 as requested by the user 101A according to the time of day data maintained by the internal clock logic (e.g. modification of the ID database 105 by the user 101A may be allowed during a work day while modification of the ID database 105 by the user 101A may be restricted during specified off time).

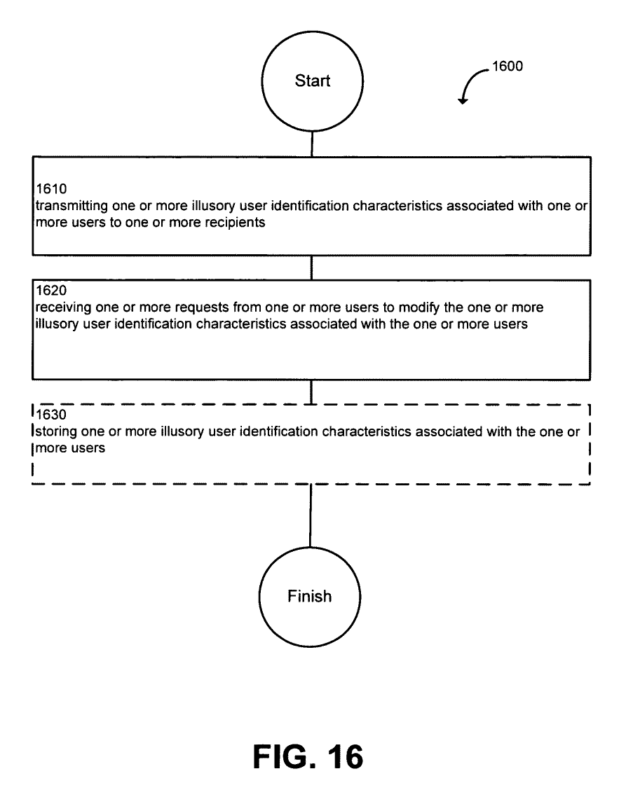

FIG. 16 illustrates an operational flow 1600 representing example operations related to transmitting illusory user identification characteristics. Operations 1610 and 1620 of operational flow 1600 may be similar to those of operations 210 and 220 respectively, as described above with respect to operational flow 200. Operational flow 1600 may include one or more additional operations. Additional operations may include an operation 1630.

Operation 1610 depicts transmitting one or more illusory user identification characteristics associated with one or more users to one or more recipients. For example, as shown in FIG. 1, the communications data transceiver module 102 of the carrier/service provider server 100 may transmit data 110B including illusory ID data 105-2A associated with user 101A to a recipient communications device 106B associated with a recipient 101B. The illusory ID data 105-2A may be received by a communications module 106-2B of the recipient communications device 106B and presented to the recipient 101B via the user interface 106-3B of the recipient communications device 106B. The communications data transceiver module 102 may transmit data 110B in any number of communications data formats including, but not limited to a voice call (e.g. a landline or wireless phone call), a text message, an instant message, an e-mail or a VoIP call.

The operation 1620 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104.

Operation 1630 depicts storing one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104 (e.g. RAM, ROM, flash memory, and the like). The ID management logic 103-1 may store one or more illusory user identification characteristics associated with the one or more users according to the request by the user 101A. A stored illusory user identification characteristic may be persistently or semi-persistently maintained in memory 104 so as to permit follow-up analysis of system usage (e.g. forensic analysis of the frequency of use of one or more illusory user identification characteristics).

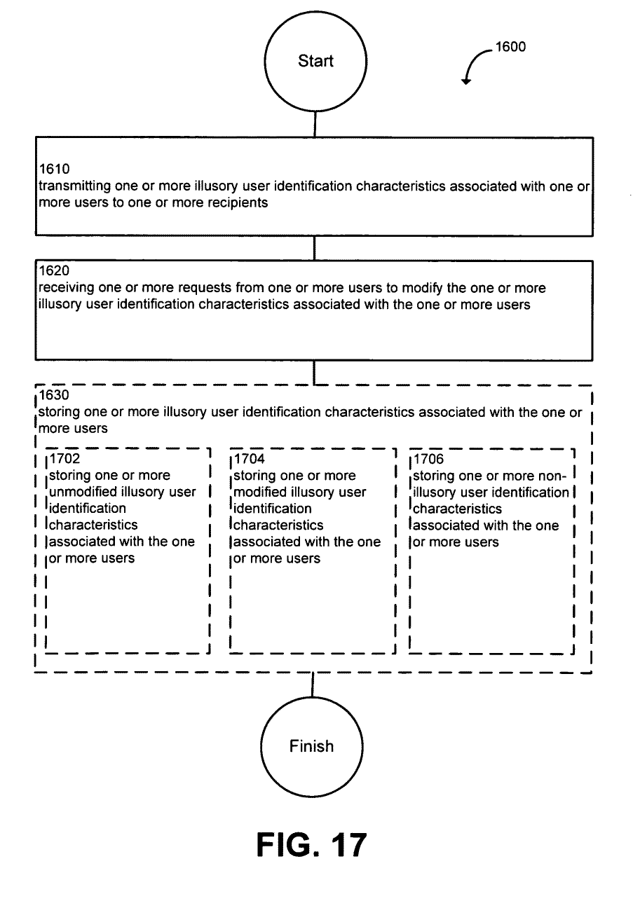

FIG. 17 illustrates alternative embodiments of the example operational flow 1600 of FIG. 16. FIG. 17 illustrates example embodiments where the operation 1630 may include at least one additional operation. Additional operations may include an operation 1702, an operation 1704, an operation, and/or an operation 1706.

Operation 1702 depicts storing one or more unmodified illusory user identification characteristics associated with the one or more users. For example, as shown in FIG. 1, the user 101A may provide an input through a user interface 106-3A of user communications device 106A whereby the user 101A requests that the carrier/service provider server 100 create a new illusory user identification characteristic (e.g. an illusory user image and recipient data 105B). The ID management logic 103-1 may store the newly created illusory user identification characteristic may be stored in memory 104 (e.g. stored as user data 105A, recipient data 105B, or user data 105A).

Operation 1704 depicts storing one or more modified illusory user identification characteristics associated with the one or more users. For example, as shown in FIG. 1, the user 101A may provide an input through a user interface 106-3A of user communications device 106A whereby the user 101A requests that the carrier/service provider server 100 modify (e.g. alter, add, remove, replace and/or view user data 105A, recipient data 105B, or user data 105A and recipient data 105B) a pre-existing illusory user identification characteristic maintained in memory 104. The ID management logic 103-1 may store the modified illusory user identification characteristic may be stored in memory 104 (e.g. stored as user data 105A, recipient data 105B, or user data 105A). The modified illusory user identification characteristic may overwrite the pre-existing illusory user identification characteristic or be stored to a separate memory location so as to preserve the pre-existing illusory user identification characteristic for future retrieval.

Operation 1706 depicts storing one or more non-illusory user identification characteristics associated with the one or more users. For example, as shown in FIG. 1, the user 101A may provide an input through a user interface 106-3A of user communications device 106A whereby the user 101A requests that the carrier/service provider server 100 modify non-illusory ID data 105-1A and/or non-illusory ID data 105-1B. The communications data transceiver module 102 of the carrier/service provider server 100 may receive data 110A including the request by the user 101A made from the user communications device 106A to modify ID database 105 maintained in memory 104. The ID management logic 103-1 may store one or more non-illusory user identification characteristics associated with the one or more users according to the request by the user 101A.

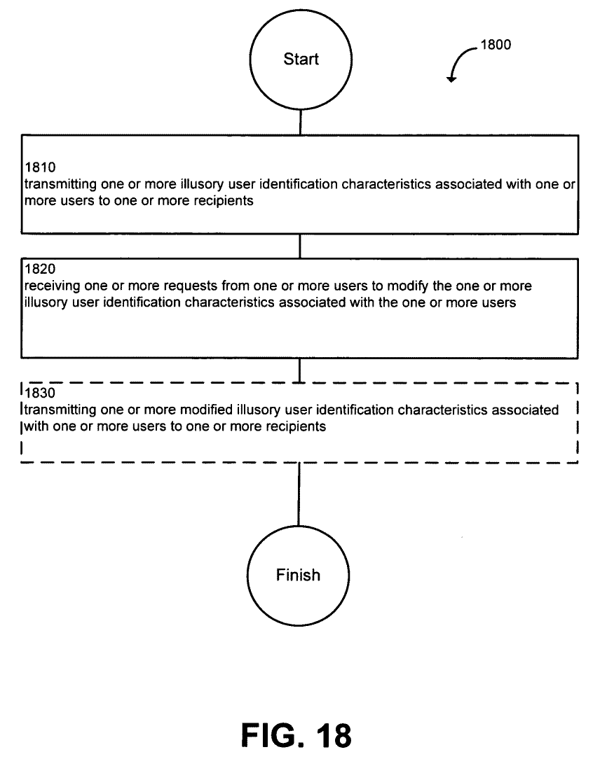

FIG. 18 illustrates an operational flow 1800 representing example operations related to transmitting illusory user identification characteristics. Operations 1810 and 1820 of operational flow 1800 may be similar to those of operations 210 and 220 respectively, as described above with respect to operational flow 200. Operational flow 1800 may include one or more additional operations. Additional operations may include an operation 1830.

Operation 1810 depicts transmitting one or more illusory user identification characteristics associated with one or more users to one or more recipients. For example, as shown in FIG. 1, the communications data transceiver module 102 of the carrier/service provider server 100 may transmit data 110B including illusory ID data 105-2A associated with user 101A to a recipient communications device 106B associated with a recipient 101B. The illusory ID data 105-2A may be received by a communications module 106-2B of the recipient communications device 106B and presented to the recipient 101B via the user interface 106-3B of the recipient communications device 106B. The communications data transceiver module 102 may transmit data 110B in any number of communications data formats including, but not limited to a voice call (e.g. a landline or wireless phone call), a text message, an instant message, an e-mail or a VoIP call.

The operation 1820 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104.

The operation 1830 depicts transmitting one or more modified illusory user identification characteristics associated with one or more users to one or more recipients. For example, as shown in FIG. 1, the communications data transceiver module 102 of carrier/service provider server 100 may receive a request from user 101A to modify the ID database 105. The database modification logic 103-5 may modify (e.g. alter, add, remove, replace and/or display) illusory ID data 105-2A in response to the request from the user 101A. Following a modification of illusory ID data 105-2A, the communications data transceiver module 102 of the carrier/service provider server 100 may transmit data 110B including modified illusory ID data 105-2A associated with user 101A to a recipient communications device 106B associated with recipient 101B.

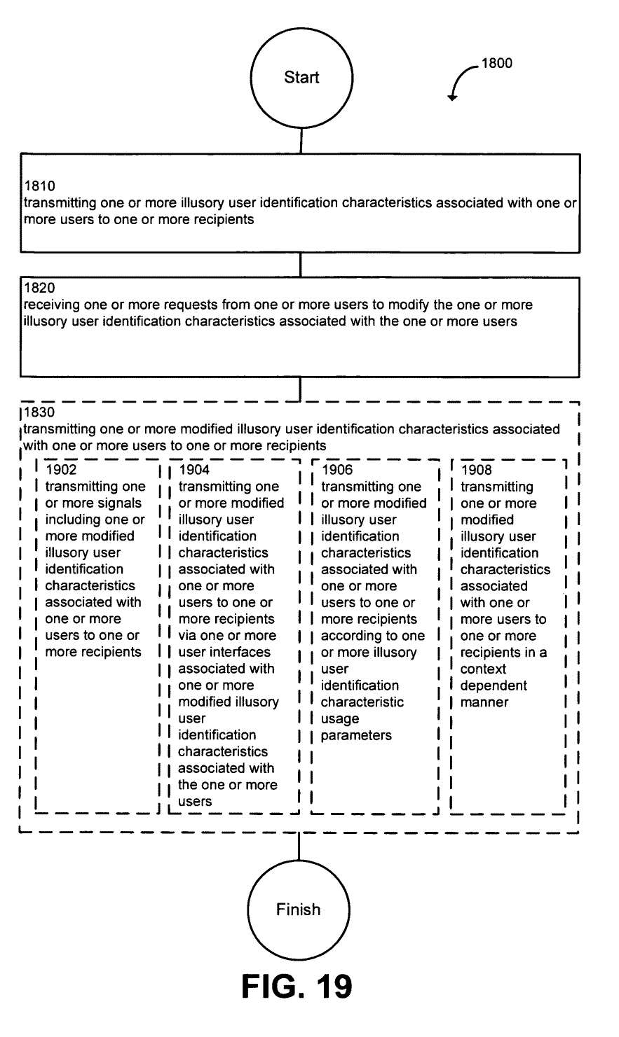

FIG. 19 illustrates alternative embodiments of the example operational flow 1800 of FIG. 18. FIG. 19 illustrates example embodiments where the operation 1830 may include at least one additional operation. Additional operations may include an operation 1902, an operation 1904, an operation 1906, and/or an operation 1908.

The operation 1902 depicts transmitting one or more signals including one or more modified illusory user identification characteristics associated with one or more users to one or more recipients. For example, as shown in FIG. 1, the communications data transceiver module 102 of the carrier/service provider server 100 may transmit data 110B including signals (e.g. electrical signals, radio frequency signals, and the like) including modified illusory ID data 105-2A (e.g. a user image modified per a request received from a user 101A) associated with user 101A to a recipient communications device 106B associated with recipient 101B. The signals including the modified illusory ID data 105-2A may be received by a communications module 106-2B of the recipient communications device 106B and presented to the recipient 101B via the user interface 106-3B of the recipient communications device 106B. The communications data transceiver module 102 may transmit signals data 110B for any number of communication purposes including, but not limited to voice calls (e.g. a landline or wireless phone call), a text messages, an e-mails or a VoIP calls.

The operation 1904 depicts transmitting one or more modified illusory user identification characteristics associated with one or more users to one or more recipients via one or more user interfaces associated with one or more modified illusory user identification characteristics associated with the one or more users. For example, as shown in FIG. 1, the communications data transceiver module 102 of the carrier/service provider server 100 may transmit data 110B including modified illusory ID data 105-2A (e.g. a user image modified per a request received from a user 101A) associated with user 101A to a recipient communications device 106B associated with recipient 101B. The data 110B may further include user interface instructions which may cause recipient communications device 106B to present a particular user interface 106-3B to recipient 101B including the modified illusory ID data 105-2A. The user interface 106-3B may include various displayed images, tones, user input options, and the like, which are associated with the modified illusory ID data 105-2A.

The operation 1906 depicts transmitting one or more modified illusory user identification characteristics associated with one or more users to one or more recipients according to one or more illusory user identification characteristic usage parameters. For example, as shown in FIG. 1, the communications data transceiver module 102 of the carrier/service provider server 100 may transmit data 110B including modified illusory ID data 105-2A associated with user 101A to a recipient communications device 106B associated with recipient 101B according to an illusory user identification characteristic usage parameter (e.g. a location parameter, a time parameter, a proximity parameter). An illusory user identification characteristic usage parameter may control the manner in which the modified illusory ID data 105-2A is provided to recipient 101B (e.g. the modified illusory ID data 105-2A may only be transmitted to recipient 101B at certain times of the day while non-illusory ID data 105-1 may be transmitted to recipient 101B at other times of the day).

The operation 1908 depicts transmitting one or more modified illusory user identification characteristics associated with one or more users to one or more recipients in a context dependent manner. For example, as shown in FIG. 1, the communications data transceiver module 102 of the carrier/service provider server 100 may transmit data 110B including modified illusory ID data 105-2A associated with user 101A to a recipient communications device 106B associated with recipient 101B according to a context (e.g. a location of user 101A, a location of the recipient 101B, a proximity of a third party 101C to user 101A and/or the recipient 10B, and the like) of the user 101A. For example, the modified illusory ID data 105-2A may only be transmitted to recipient 101B when context data (e.g. a GPS location of recipient communications device 106B) indicates a likelihood that recipient 101B is alone while non-illusory ID data 105-1 may be transmitted to recipient 101B when context data indicates a likelihood that the recipient 101B is in proximity of a third party 101C.

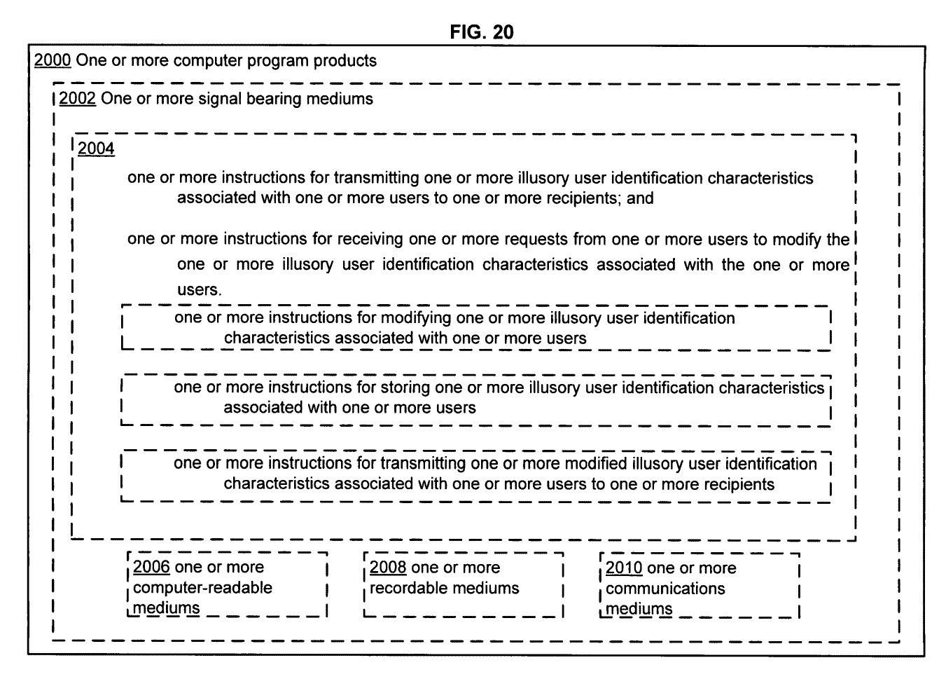

FIG. 20 illustrates a partial view of an example computer program product 2000 that includes a computer program 2004 for executing a computer process on a computing device. An embodiment of the example computer program product 2000 is provided using a signal-bearing medium 2002, and may include one or more instructions for transmitting one or more illusory user identification characteristics associated with one or more users to one or more recipients; and one or more instructions for receiving one or more requests from one or more users to modify the one or more illusory user identification characteristics associated with the one or more users. The one or more instructions may be, for example, computer executable and/or logic-implemented instructions. In one implementation, the signal-bearing medium 2002 may include a computer-readable medium 2006. In one implementation, the signal bearing medium 2002 may include a recordable medium 2008. In one implementation, the signal bearing medium 2002 may include a communications medium 2010.

The computer program product 2000 may include one or more instructions for modifying one or more illusory user identification characteristics associated with the one or more users.

The computer program product 2000 may include one or more instructions for storing one or more illusory user identification characteristics associated with the one or more users.

The computer program product 2000 may include one or more instructions for transmitting one or more modified illusory user identification characteristics associated with one or more users to one or more recipients.

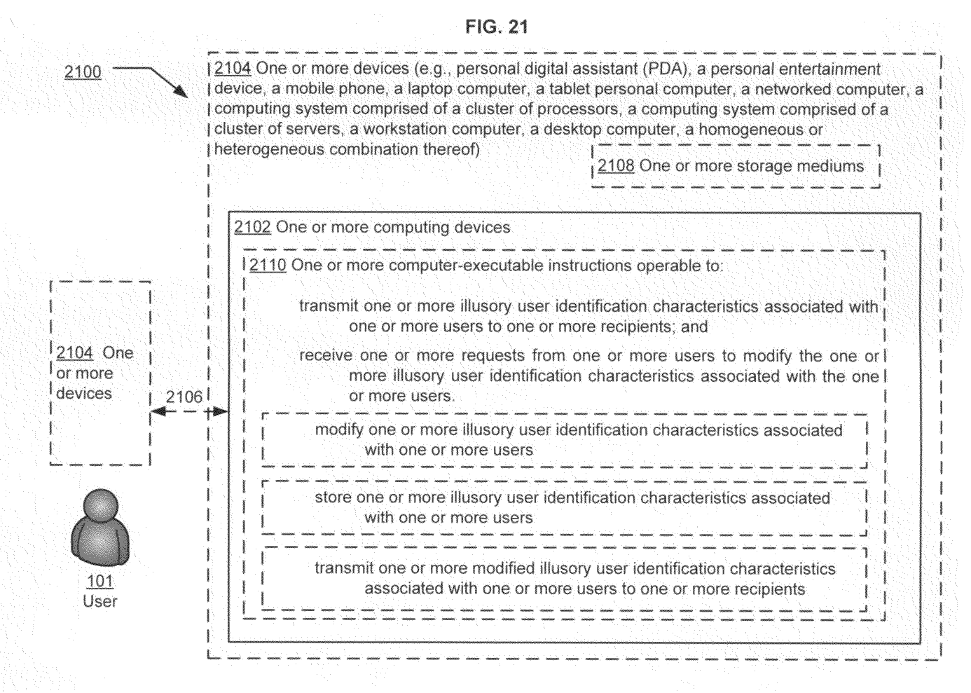

FIG. 21 illustrates an example system 2100 in which embodiments may be implemented. The system 2100 includes a computing system environment. The system 2100 also illustrates a user 101 using a device 2104, which is optionally shown as being in communication with a computing device 2102 by way of an optional coupling 2106. The optional coupling 2106 may represent a local, wide-area, or peer-to-peer network, or may represent a bus that is internal to a computing device (e.g., in example embodiments in which the computing device 2102 is contained in whole or in part within the device 2104). A storage medium 2108 may be any computer storage media.

The computing device 2102 includes computer-executable instructions 2110 that when executed on the computing device 2102 cause the computing device 2102 to transmit one or more illusory user identification characteristics associated with one or more users to one or more recipients; receive one or more requests from one or more users to modify the one or more illusory user identification characteristics associated with the one or more users. As referenced above and as shown in FIG. 21, in some examples, the computing device 2102 may optionally be contained in whole or in part within the device 2104.

The computing device 2102 may include computer-executable instructions that, when executed on the computing device 2102, cause the computing device 2102 to modify one or more illusory user identification characteristics associated with one or more users.

The computing device 2102 may include computer-executable instructions that, when executed on the computing device 2102, cause the computing device 2102 to store one or more illusory user identification characteristics associated with one or more users.

The computing device 2102 may include computer-executable instructions that, when executed on the computing device 2102, cause the computing device 2102 to transmit one or more modified illusory user identification characteristics associated with one or more users to one or more recipients.

In FIG. 21, the system 2100 includes at least one computing device (e.g., 2102 and/or 2104). The computer-executable instructions 2110 may be executed on one or more of the at least one computing device. For example, the computing device 2102 may implement the computer-executable instructions 2110 and output a result to (and/or receive data from) the computing device 2102. Since the computing device 2102 may be wholly or partially contained within the device 2104, the device 2104 also may be said to execute some or all of the computer-executable instructions 2110, in order to be caused to perform or implement, for example, various ones of the techniques described herein, or other techniques.

The device 2104 may include, for example, a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer. In another example embodiment, the computing device 2102 is operable to communicate with the device 2104 associated with the user 101 to receive information about the input from the user 101 for performing data access and data processing related to illusory user identification characteristics.

Further, the device 2104 may include a heterogeneous computing network including two or more of a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer, operably coupled to a common computing network.

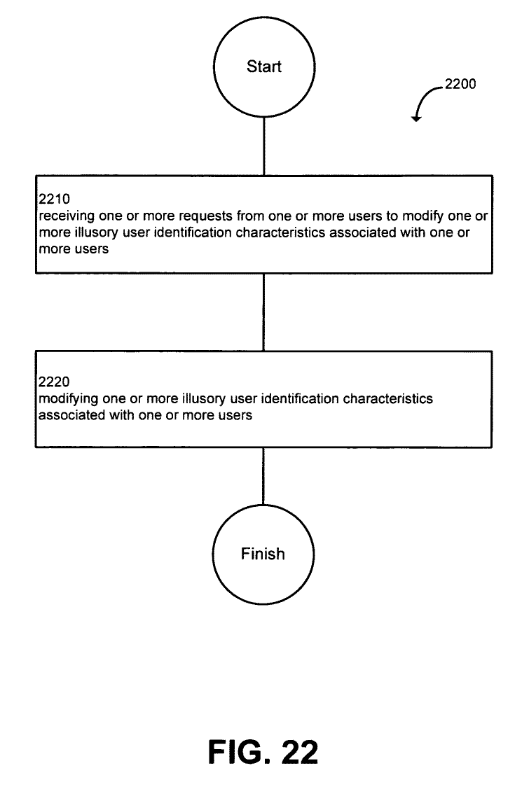

FIG. 22 illustrates an operational flow 2200 representing example operations related to transmitting illusory user identification characteristics.

After a start operation, the operational flow 2200 moves to an operation 2210. The operation 2210 illustrates receiving one or more requests from one or more users to modify one or more illusory user identification characteristics associated with one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify ID database 105 (e.g. alter, add, remove, replace and/or view user data 105A, recipient data 105B, or user data 105A and recipient data 105B). The communications data transceiver module 102 of the carrier/service provider server 100 may receive data 110A including a request by the user 101A made from a user communications device 106A to modify ID database 105 maintained in memory 104.

The operation 2220 illustrates modifying one or more illusory user identification characteristics associated with the one or more users. For example, as shown in FIG. 1, the communications data transceiver module 102 of carrier/service provider server 100 may receive a request from user 101A to modify the ID database 105 (e.g. a request to alter a user name, image, voice signature, and the like). The database modification logic 103-5 of the carrier/service provider server 100 may modify the user data 105A, recipient data 105B, or user data 105A and recipient data 105B as requested by the user 101A by overwriting and/or remapping the user data 105A, recipient data 105B, or user data 105A and recipient data 105B to correspond to data representing the modified user characteristic (e.g. an updated voice signature having a lower pitch than the actual voice signature of user 101A).

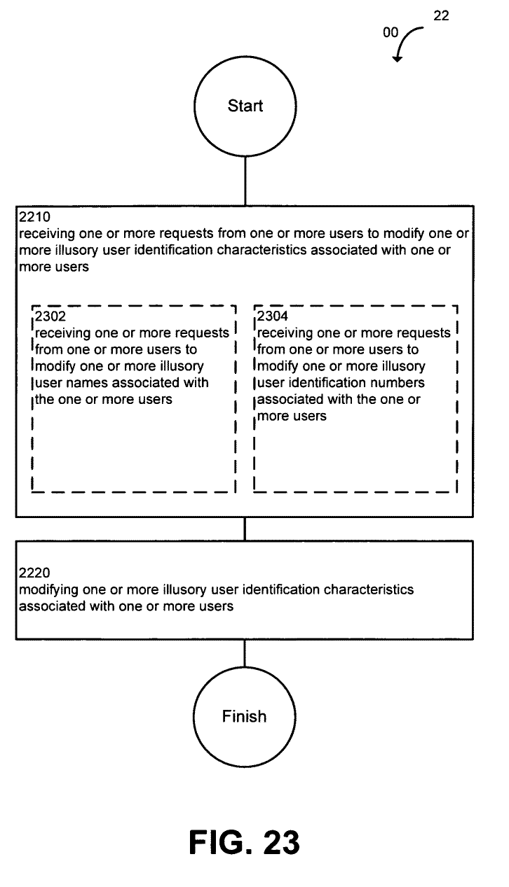

FIG. 23 illustrates alternative embodiments of the example operational flow 2200 of FIG. 22. FIG. 23 illustrates example embodiments where the operation 2210 may include at least one additional operation. Additional operations may include an operation 2302 and/or an operation 2304.

The operation 2302 illustrates receiving one or more requests from one or more users to modify one or more illusory user names associated with the one or more users. For example, as shown in FIG. 1, the carrier/service provider server 100 may receive a request from the user 101A to modify an illusory user name maintained as illusory ID data 105-2A associated with user 101A. A request to modify an associated illusory user identification name may be inputted by user 101A via user interface 106-3A of user communications device 106A and transmitted as part of data 110A from the user communications device 106A and received by the communications data transceiver module 102 of the carrier/service provider server 100.

The operation 2304 illustrates receiving one or more requests from one or more users to modify one or more illusory user identification numbers associated with the one or more users. For example, as shown in FIG. 1, the carrier/service provider server 100 may receive a request from the user 101A to modify an illusory user identification number (e.g. a social security number) maintained as illusory ID data 105-2A associated with user 101A. A request to modify an associated illusory user identification number may be inputted by user 101A via user interface 106-3A of user communications device 106A and transmitted as part of data 110A from the user communications device 106A and received by the communications data transceiver module 102 of the carrier/service provider server 100.

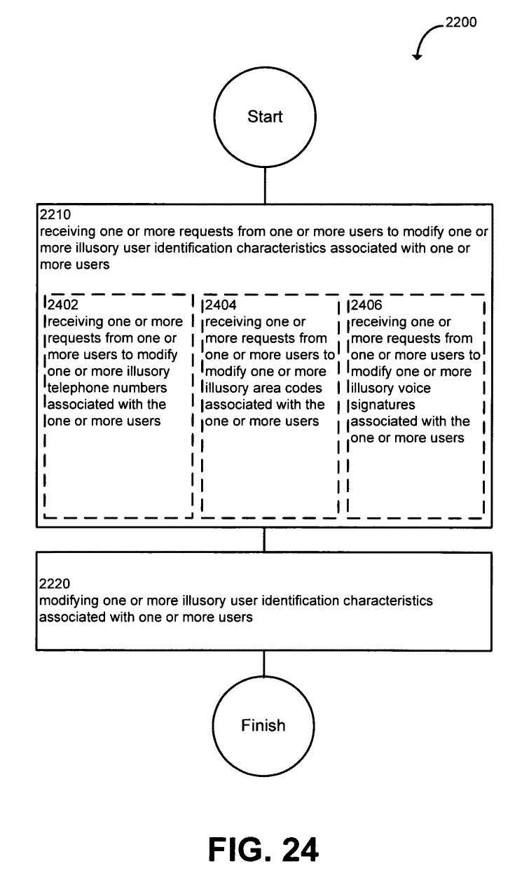

FIG. 24 illustrates alternative embodiments of the example operational flow 2200 of FIG. 22. FIG. 24 illustrates example embodiments where the operation 2210 may include at least one additional operation. Additional operations may include an operation 2402, an operation 2404 and/or an operation 2406.

The operation 2402 illustrates receiving one or more requests from one or more users to modify one or more illusory telephone numbers associated with the one or more users. For example, as shown in FIG. 1, the carrier/service provider server 100 may receive a request from the user 101A to modify an illusory user telephone number maintained as illusory ID data 105-2A associated with user 101A. A request to modify an associated illusory user telephone number may be inputted by user 101A via user interface 106-3A of user communications device 106A and transmitted as part of data 110A from the user communications device 106A and received by the communications data transceiver module 102 of the carrier/service provider server 100.

The operation 2404 illustrates receiving one or more requests from one or more users to modify one or more illusory area codes associated with the one or more users. For example, as shown in FIG. 1, the carrier/service provider server 100 may receive a request from the user 101A to modify an illusory user area code (e.g. an international dialing code, country codes, city codes, cell phone codes, NANPA codes, ITU-T code, a code established under the North American Numbering Plan, and the like) maintained as illusory ID data 105-2A associated with user 101A. A request to modify an associated illusory user area code may be inputted by user 101A via user interface 106-3A of user communications device 106A and transmitted as part of data 110A from the user communications device 106A and received by the communications data transceiver module 102 of the carrier/service provider server 100.

The operation 2406 illustrates receiving one or more requests from one or more users to modify one or more illusory voice signatures associated with the one or more users. For example, as shown in FIG. 1, the carrier/service provider server 100 may receive a request from the user 101A to modify an illusory user voice signature (e.g. a voice signature having an altered pitch, tone, volume relative to the actual voice signature of user 101A) maintained as illusory ID data 105-2A associated with user 101A. A request to modify an associated illusory user voice signature may be inputted by user 101A via user interface 106-3A of user communications device 106A and transmitted as part of data 110A from the user communications device 106A and received by the communications data transceiver module 102 of the carrier/service provider server 100.

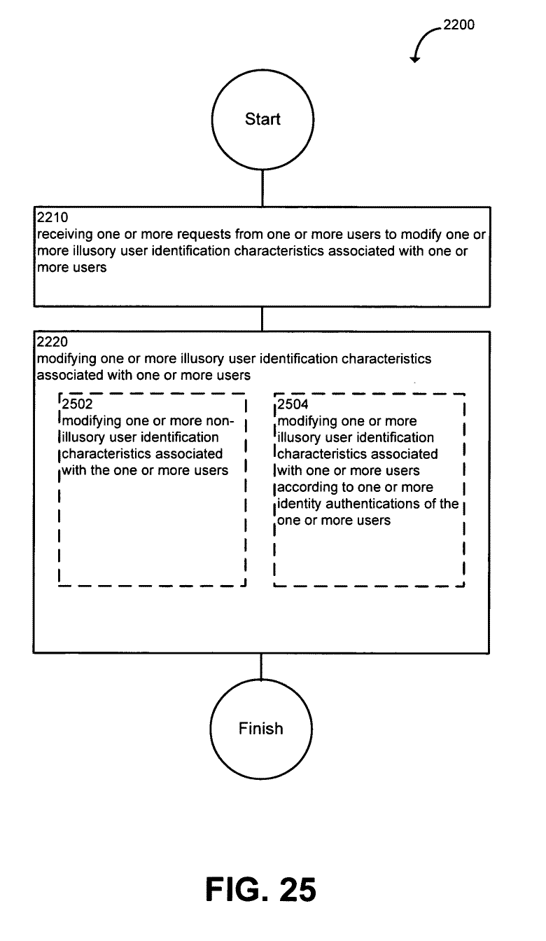

FIG. 25 illustrates alternative embodiments of the example operational flow 2200 of FIG. 22. FIG. 25 illustrates example embodiments where the operation 2220 may include at least one additional operation. Additional operations may include an operation 2502 and/or an operation 2504.

The operation 2502 illustrates modifying one or more non-illusory user identification characteristics associated with the one or more users. For example, as shown in FIG. 1, the communications data transceiver module 102 of carrier/service provider server 100 may receive a request from the user 101A to modify the ID database 105 including non-illusory ID data 105-1A maintained in memory 104. The database modification logic 103-5 may authenticate an identity of the user 101A (e.g. a password identity authentication, a biometric identity authentication, and the like) and allow modification (e.g. allow alteration, replacement, addition of user data 105A and/or recipient data 105B, allow viewing of communications records, and the like) to the ID database 105 via one or more access portals (e.g. a web interface, touch tone phone interface, a voice recognition interface, a graphical user interface, and the like). A request to modify non-illusory ID data 105-1A may be inputted by user 101A via user interface 106-3A of user communications device 106A and transmitted as part of data 110A from the user communications device 106A and received by the communications data transceiver module 102 of the carrier/service provider server 100.

The operation 2504 illustrates modifying one or more illusory user identification characteristics associated with the one or more users according to one or more identity authentications of the one or more users. For example, as shown in FIG. 1, the carrier/service provider server 100 may receive identity authentication data 110A (e.g. a password identity authentication, a biometric identity authentication, and the like) from the user 101A which contains certain information specific to the user 101A so as to verify that only an authorized user 101A may modify the ID database 105. The authentication logic 103-2 may receive the identity authentication data 110A and compare it to identity authentication data 105-3A associated with user 101A. Upon verification that identity authentication data 110A (e.g. password data, biometric data, and the like) received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

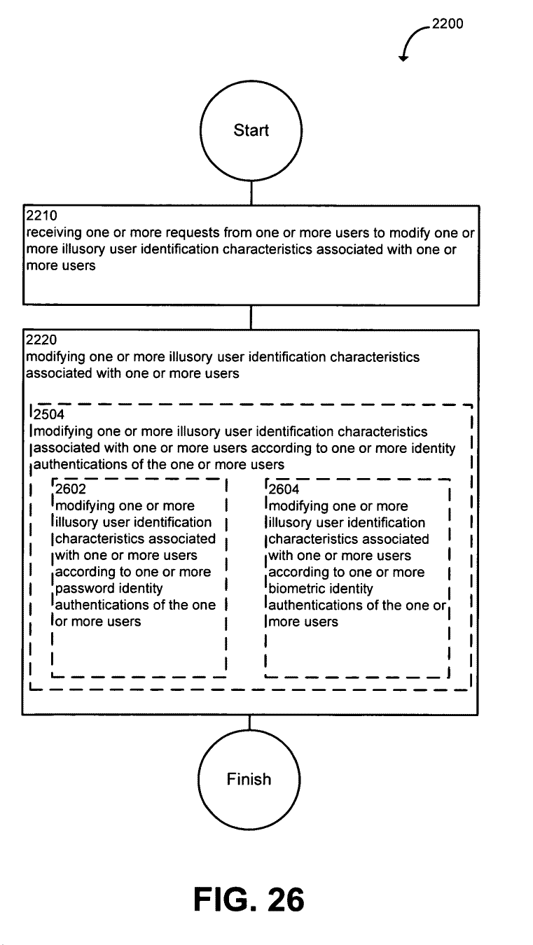

FIG. 26 illustrates alternative embodiments of the example operational flow 2200 of FIG. 25. FIG. 26 illustrates example embodiments where the operation 2504 of FIG. 25 may include at least one additional operation. Additional operations may include an operation 2602, and/or an operation 2604.

The operation 2602 illustrates modifying one or more illusory user identification characteristics associated with the one or more users according to one or more password identity authentications of the one or more users. For example, as shown in FIG. 1, the user 101A may provide an input through a user interface 106-3A of user communications device 106A whereby the user 101A transmits a password in the form of password data 110A to the carrier/service provider server 100. The carrier/service provider server 100 may receive the password identity authentication data 110A from the user 101A which contains a password specific to user 101A so as to verify that only an authorized user is attempting to modify the ID database 105. The authentication logic 103-2 may receive the password identity authentication data 110A and compare it to identity authentication data 105-3A associated with user 101A. Upon verification that the password identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 2604 illustrates modifying one or more illusory user identification characteristics associated with one or more users according to one or more biometric identity authentications of the one or more users. For example, as shown in FIG. 1, the user 101A may provide an input through a user interface 106-3A of user communications device 106A whereby the user 101A transmits a biometric identity authentication (e.g. DNA sampling, facial recognition, facial thermograph, eye scans, hand/vein geometry, scent analysis and the like) in the form of biometric identity authentication data 110A to the carrier/service provider server 100. The carrier/service provider server 100 may receive the biometric identity authentication data 110A from the user 101A which contains biometric data specific to that user so as to verify that only an authorized user is attempting to modify the ID database 105. The authentication logic 103-2 may receive the biometric identity authentication data 110A and compare it to identity authentication data 105-3A associated with user 101A. Upon verification that the biometric identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

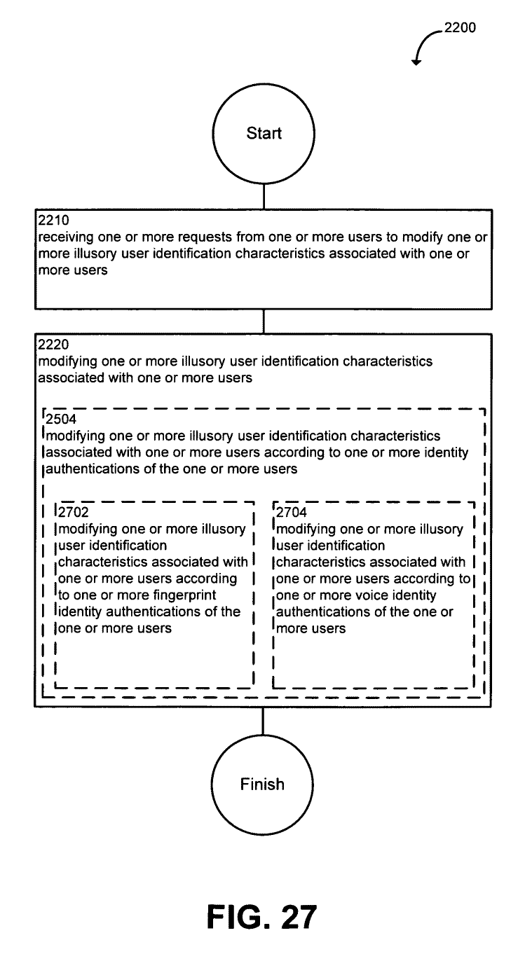

FIG. 27 illustrates alternative embodiments of the example operational flow 2200 of FIG. 25. FIG. 27 illustrates example embodiments where the operation 2504 may include at least one additional operation. Additional operations may include an operation 2702 and/or an operation 2704.

The operation 2702 illustrates modifying one or more illusory user identification characteristics associated with one or more users according to one or more fingerprint identity authentications of the one or more users. For example, as shown in FIG. 1, the user 101A may provide an input through a user interface 106-3A (e.g. a fingerprint scanner) of user communications device 106A whereby the user 101A transmits a fingerprint identity authentication in the form of fingerprint identity authentication data 110A to the carrier/service provider server 100. The carrier/service provider server 100 may receive the fingerprint identity authentication data 110A from the user 101A which contains fingerprint data specific to user 101A so as to verify that only an authorized user is attempting to modify the ID database 105. The authentication logic 103-2 may receive the fingerprint identity authentication data 110A and compare it to identity authentication data 105-3A associated with user 101A. Upon verification that the fingerprint identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 2704 illustrates modifying one or more illusory user identification characteristics associated with one or more users according to one or more voice identity authentications of the one or more users. For example, as shown in FIG. 1, the user 101A may provide an input through a user interface 106-3A (e.g. a microphone operably coupled to voice recognition circuitry) of user communications device 106A whereby the user 101A transmits a voice identity authentication in the form of voice identity authentication data 110A to the carrier/service provider server 100. The carrier/service provider server 100 may receive the voice identity authentication data 110A from the user 101A which contains voice data specific to user 101A so as to verify that only an authorized user is attempting to modify the ID database 105. The authentication logic 103-2 may receive the voice identity authentication data 110A and compare it to identity authentication data 105-3A associated with user 101A. Upon verification that the voice identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

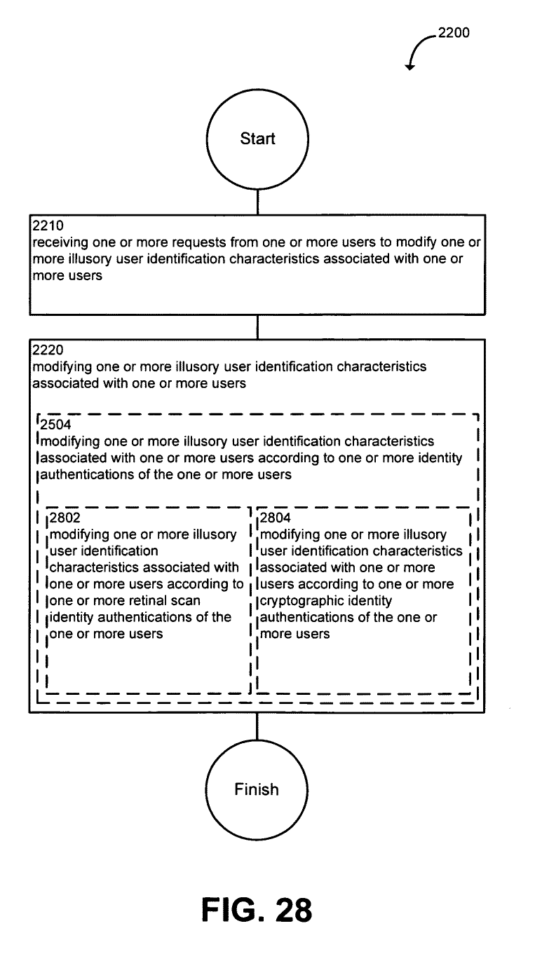

FIG. 28 illustrates alternative embodiments of the example operational flow 2200 of FIG. 25. FIG. 28 illustrates example embodiments where the operation 2504 may include at least one additional operation. Additional operations may include an operation 2802 and/or an operation 2804.

The operation 2802 illustrates modifying one or more illusory user identification characteristics associated with one or more users according to one or more retinal scan identity authentications of the one or more users. For example, as shown in FIG. 1, the user 101A may provide an input through a user interface 106-3A (e.g. a retinal scanner) of user communications device 106A whereby the user 101A transmits a retinal scan identity authentication in the form of retinal scan identity authentication data 110A to the carrier/service provider server 100. The carrier/service provider server 100 may receive the retinal scan identity authentication data 110A from the user 101A which contains retinal scan data specific to that user so as to verify that only an authorized user is attempting to modify the ID database 105. The authentication logic 103-2 may receive the retinal scan identity authentication data 110A and compare it to identity authentication data 105-3A associated with user 101A. Upon verification that the retinal scan identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

The operation 2804 illustrates modifying one or more illusory user identification characteristics associated with one or more users according to one or more cryptographic identity authentications of the one or more users. For example, as shown in FIG. 1, the user 101A may provide an input (e.g. a key associated with a cipher implemented by the communications data transceiver module 102 and/or the recipient communications device 106B) through a user interface 106-3A (e.g. a keypad) of user communications device 106A whereby the user 101A transmits a cryptographic identity authentication in the form of cryptographic identity authentication data 110A to the carrier/service provider server 100. The carrier/service provider server 100 may receive the cryptographic identity authentication data 110A from the user 101A which contains cryptographic data specific to that user so as to verify that only an authorized user is attempting to modify the ID database 105. The authentication logic 103-2 may receive the cryptographic identity authentication data 110A and compare it to identity authentication data 105-3A associated with user 101A. Upon verification that the cryptographic identity authentication data 110A received from user 101A corresponds to identity authentication data 105-3A associated with the user 101A maintained in memory 104 by the carrier/service provider server 100, the database modification logic 103-5 of the carrier/service provider server 100 may modify the ID database 105 as requested by the user 101A.

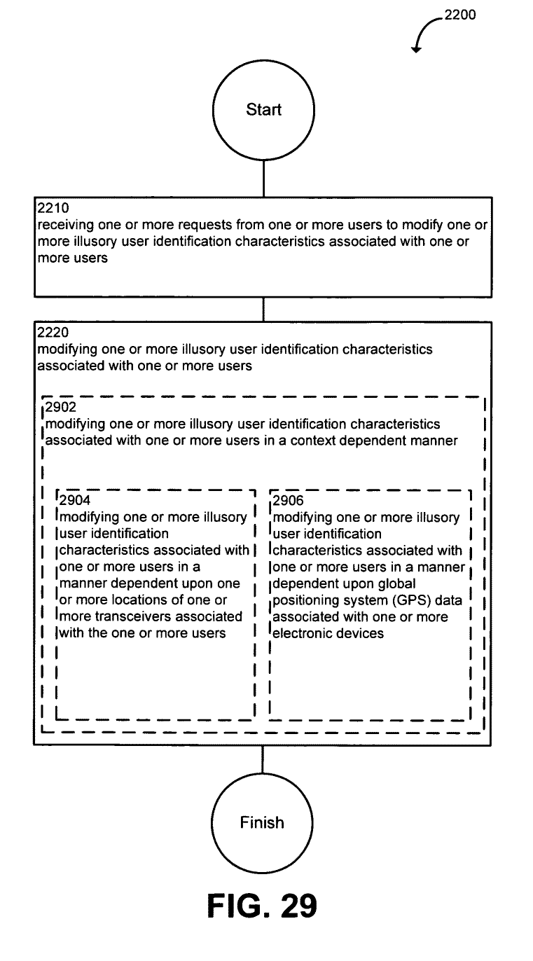

FIG. 29 illustrates alternative embodiments of the example operational flow 2200 of FIG. 22. FIG. 29 illustrates example embodiments where the operation 2220 may include at least one additional operation. Additional operations may include an operation 2902.

The operation 2902 illustrates modifying one or more illusory user identification characteristics associated with the one or more users in a context dependent manner. For example, as shown in FIG. 1, the database modification logic 103-5 of the carrier/service provider server 100 may modify user data 105A as requested by the user 101A according to a context (e.g. a location of user 101A, a proximity of a third party 101C to user 101A, and the like) of the user 101A. The database modification logic 103-5 may cause the carrier/service provider server 100 to modify user data 105A as requested by the user 101A when the context of user 101A indicates a low likelihood of the presence of a third party 101C so as to avoid disclosure of the contents of user data 105A.

FIG. 29 illustrates further example embodiments where the operation 2902 may include at least one additional operation. Additional operations may include an operation 2904 and/or an operation 2906.

The operation 2904 illustrates modifying one or more illusory user identification characteristics associated with the one or more users in a manner dependent upon one or more locations of one or more transceivers associated with the one or more users. For example, as shown in FIG. 1, the communications module 106-2A of the user communications device 106A associated with the user 101A may include one or more transceivers (e.g. RF transceivers, optical transceivers, modem transceivers, and the like) for transceiving data 110A from the carrier/service provider server 100. The carrier/service provider server 100 may detect the location of the user communications device 106A through communication with the transceiver of the user communications device 106A. The carrier/service provider server 100 may identify the location by monitoring a geographic indicator (e.g. a cell tower location, e-mail service provider, telephone area code, network IP address, and the like) associated with the transceiver of the user communications device 106A. The database modification logic 103-5 may cause the carrier/service provider server 100 to modify user data 105A as requested by the user 101A according to the location of the one or more transceivers (e.g. modification of the user data 105A by the user 101A may be allowed when the transceiver context data indicates that user 101A is in a private location such as a home or office).

The operation 2906 illustrates modifying one or more illusory user identification characteristics associated with the one or more users in a manner dependent upon global positioning system (GPS) data associated with one or more electronic devices. For example, as shown in FIG. 1, the user communications device 106A associated with user 101A may include a GPS sensor module 106-1A including one or more transceivers for receiving signals from a GPS satellite 107. GPS data 110A associated with the location of the user communications device 106A may be received by the communications data transceiver module 102 of the carrier/service provider server 100. The database modification logic 103-5 may cause the carrier/service provider server 100 to modify the user data 105A as requested by the user 101A according to the GPS data 110A (e.g. modification of the user data 105A by the user 101A may be allowed when the GPS context data indicates that user 101A is in a private location such as a home or office).

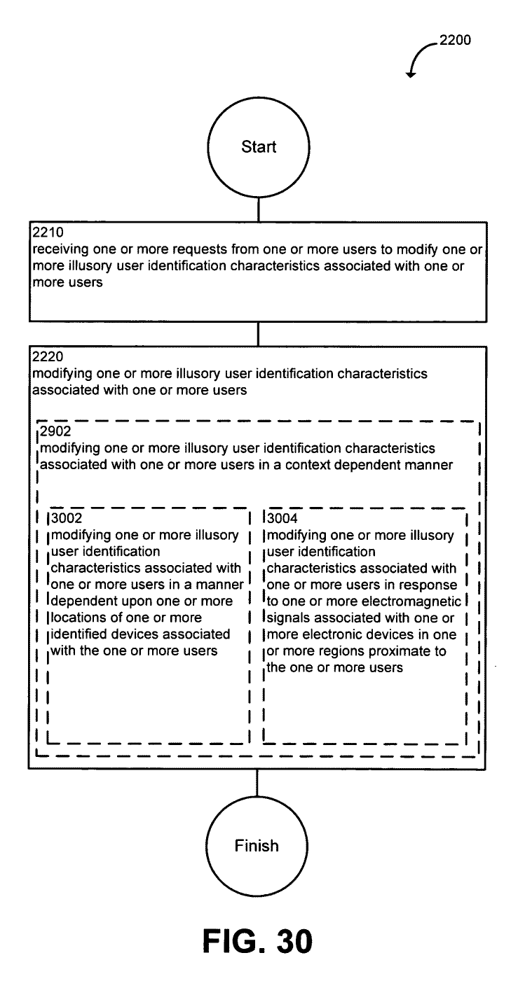

FIG. 30 illustrates alternative embodiments of the example operational flow 2200 of FIG. 29. FIG. 30 illustrates example embodiments where the operation 2902 may include at least one additional operation. Additional operations may include an operation 3002 and/or an operation 3004.

The operation 3002 illustrates modifying one or more illusory user identification characteristics associated with the one or more users in a manner dependent upon one or more locations of one or more identified devices associated with the one or more users. For example, as shown in FIG. 1, the carrier/service provider server 100 may detect the location of the user communications device 106A associated with user 101A (e.g. a cell phone, satellite phone, Blackberry®, landline phone, a VoIP enabled device and/or computing device) associated with user 101A through communication with the user communications device 106A. The carrier/service provider server 100 may identify the location by monitoring a geographic indicator (e.g. a cell tower location, e-mail service provider, telephone area code, and the like) associated with the user communications device 106A. The database modification logic 103-5 may cause the carrier/service provider server 100 to modify user data 105A as requested by the user 101A according to the location of the user communications device 106A (e.g. modification of the user data 105A by the user 101A may be allowed when the device context data indicates that user 101A is in a private location such as a home or office).

The operation 3004 illustrates modifying one or more illusory user identification characteristics associated with the one or more users in response to one or more electromagnetic signals associated with one or more electronic devices in one or more regions proximate to the one or more users. For example, as shown in FIG. 1, the user communications device 106A associated with user 101A may include a radio frequency sensor module 106-1A including one or more transceivers for receiving RF signals (e.g. signals emitted by an electronic device 108A in a region proximate to user 101A (e.g. region 109A). The data 110A associated with the RF environment proximate to the user communications device 106A may be received by the communications data transceiver module 102 of the carrier/service provider server 100. The database modification logic 103-5 may cause the carrier/service provider server 100 to modify the ID database 105 as requested by the user 101A according to the RF data 110A (e.g. modification of the ID database 105 by the user 101A may not be allowed when RF data 110A indicates that user 101A is in proximity to an electronic device 108A while modification of the ID database 105 by the user 101A may be allowed when the RF data 110A indicates that the user 101A is not in proximity to electronic device 108A).

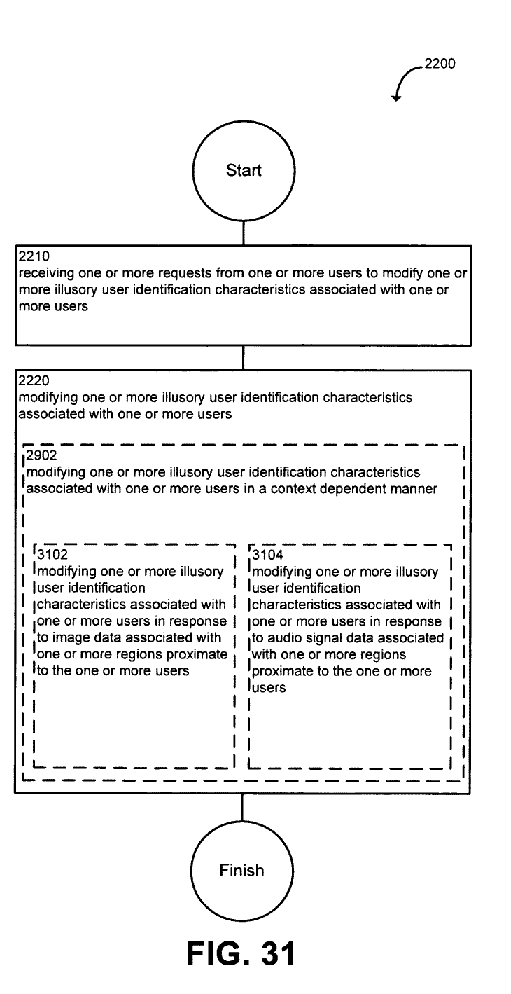

FIG. 31 illustrates alternative embodiments of the example operational flow 2200 of FIG. 29. FIG. 31 illustrates example embodiments where the operation 2902 may include at least one additional operation. Additional operations may include an operation 3102 and/or an operation 3104.

The operation 3102 illustrates modifying one or more illusory user identification characteristics associated with the one or more users in response to image data associated with one or more regions proximate to the one or more users. For example, as shown in FIG. 1, the user communications device 106A associated with user 101A may include an image sensor module 106-1A including one or more image capture devices for receiving images (e.g. images of a region proximate to user 101A such as region 109A). The image data 110A associated with the visual environment proximate to the user communications device 106A may be received by the communications data transceiver module 102 of the carrier/service provider server 100. The database modification logic 103-5 employing image recognition logic may cause the carrier/service provider server 100 to modify the ID database 105 as requested by the user 101A according to the image data 11A. Modification of the ID database 105 by the user 101A may be restricted when image data 110A indicates that the user 101A may be in proximity to a third party 101C (e.g. image recognition logic detects an image of a home, office, identified person, and the like) while modification of the ID database 105 by the user 101A may be allowed when image data 110A indicates that user 101A is not in proximity to third party 101C.

The operation 3104 illustrates modifying one or more illusory user identification characteristics associated with the one or more users in response to audio signal data associated with one or more regions proximate to the one or more users. For example, as shown in FIG. 1, the user communications device 106A associated with user 101A may include an audio sensor module 106-1A including one or more microphones for receiving audio signals (e.g. sounds emitted in a region proximate to user 101A such as region 109A). The data 110A associated with the audio environment proximate to the user communications device 106A may be received by the communications data transceiver module 102 of the carrier/service provider server 100. The database modification logic 103-5 employing audio recognition logic may cause the carrier/service provider server 100 to modify the ID database 105 as requested by the user 101A according to the audio data 110A. Modification of the ID database 105 by the user 101A may be restricted when audio data 110A indicates that the user 101A may be in proximity to a third party 101C (e.g. audio recognition logic detects sounds indicative of a home, an office, a person having an identified voice print, and the like) while modification of the ID database 105 by the user 101A may be allowed when audio data 110A indicates that user 101A is not in proximity to third party 101C.

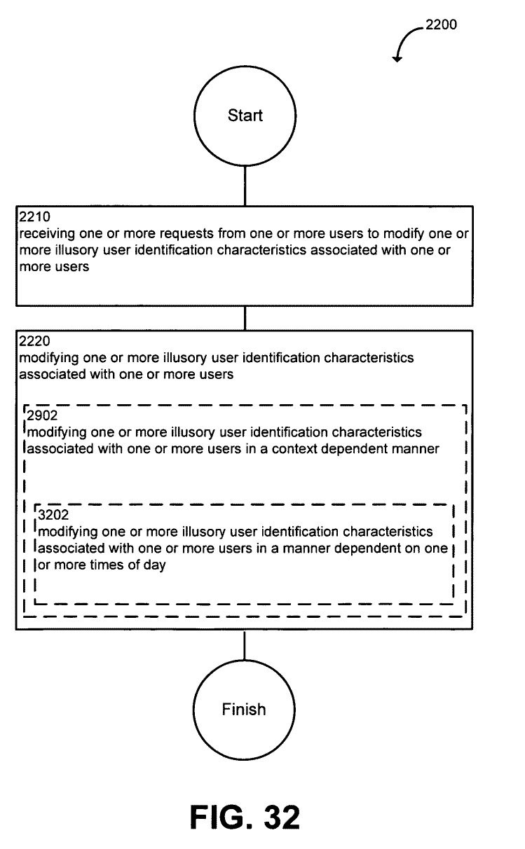

FIG. 32 illustrates alternative embodiments of the example operational flow 2200 of FIG. 29. FIG. 32 illustrates example embodiments where the operation 2902 may include at least one additional operation. Additional operations may include an operation 3202.

The operation 3202 illustrates modifying one or more illusory user identification characteristics associated with the one or more users in a manner dependent on one or more times of day. For example, as shown in FIG. 1, the database modification logic 103-5 may maintain internal clock logic and may cause the communications data transceiver module 102 of the carrier/service provider server 100 to modify the ID database 105 as requested by the user 101A according to the time of day data maintained by the internal clock logic (e.g. modification of the ID database 105 by the user 101A may be allowed during a work day while modification of the ID database 105 by the user 101A may be restricted during specified off time).

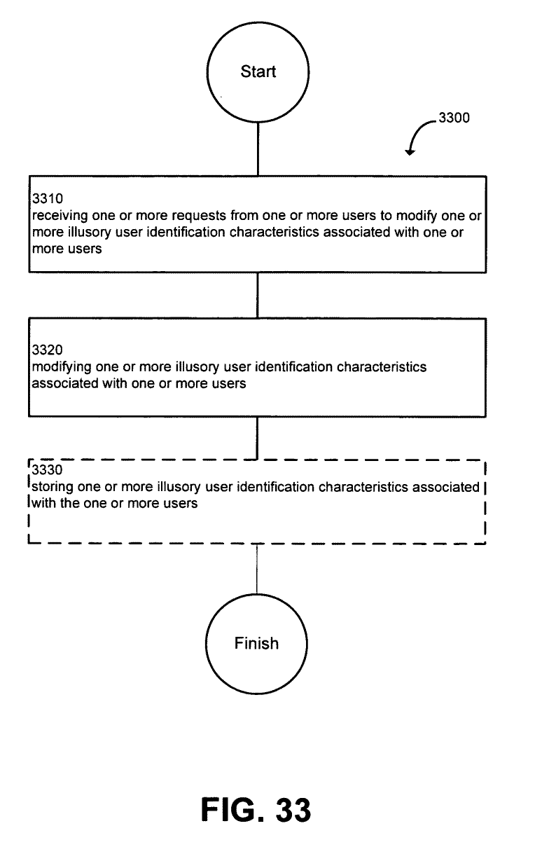

FIG. 33 illustrates an operational flow 3300 representing example operations related to transmitting illusory user identification characteristics. Operations 3310 and 3320 of operational flow 3300 may be similar to those of operations 210 and 220 respectively, as described above with respect to operational flow 200. Operational flow 3300 may include one or more additional operations. Additional operations may include an operation 3330.

The operation 3310 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify ID database 105 (e.g. alter, add, remove, replace and/or view user data 105A, recipient data 105B, or user data 105A and recipient data 105B). The communications data transceiver module 102 of the carrier/service provider server 100 may receive data 110A including a request by the user 101A made from a user communications device 106A to modify ID database 105 maintained in memory 104.

The operation 3320 illustrates modifying one or more illusory user identification characteristics associated with the one or more users. For example, as shown in FIG. 1, the communications data transceiver module 102 of carrier/service provider server 100 may receive a request from user 101A to modify the ID database 105 (e.g. a request to alter a user name, image, voice signature, and the like). The database modification logic 103-5 of the carrier/service provider server 100 may modify the user data 105A, recipient data 105B, or user data 105A and recipient data 105B as requested by the user 101A by overwriting and/or remapping the user data 105A, recipient data 105B, or user data 105A and recipient data 105B to correspond to data representing the modified user characteristic (e.g. an updated voice signature having a lower pitch than the actual voice signature of user 101A).

Operation 3330 depicts storing one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify the ID database 105 (e.g. alter, add, remove, replace and/or view user data 105A, recipient data 105B, or user data 105A and recipient data 105B). The communications data transceiver module 102 of the carrier/service provider server 100 may receive data 110A including the request by the user 101A made from the user communications device 106A to modify ID database 105 maintained in memory 104 (e.g. RAM, ROM, flash memory, and the like). The ID management logic 103-1 may store one or more illusory user identification characteristics associated with the one or more users according to the request by the user 101A. A stored illusory user identification characteristic may be persistently or semi-persistently maintained in memory 104 so as to permit follow-up analysis of system usage (e.g. forensic analysis of the frequency of use of one or more illusory user identification characteristics).

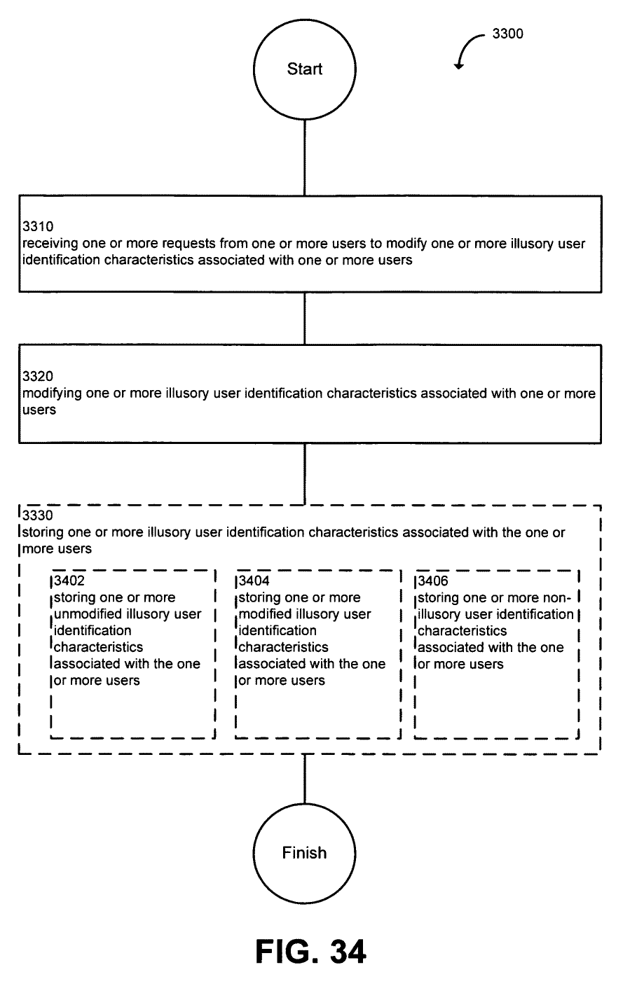

FIG. 34 illustrates alternative embodiments of the example operational flow 3300 of FIG. 33. FIG. 17 illustrates example embodiments where the operation 3330 may include at least one additional operation. Additional operations may include an operation 3402, an operation 3404, an operation, and/or an operation 3406.

Operation 3402 depicts storing one or more unmodified illusory user identification characteristics associated with the one or more users. For example, as shown in FIG. 1, the user 101A may provide an input through a user interface 106-3A of user communications device 106A whereby the user 101A requests that the carrier/service provider server 100 create a new illusory user identification characteristic (e.g. an illusory user image and recipient data 105B). The ID management logic 103-1 may store the newly created illusory user identification characteristic may be stored in memory 104 (e.g. stored as user data 105A, recipient data 105B, or user data 105A).

Operation 3404 depicts storing one or more modified illusory user identification characteristics associated with the one or more users. For example, as shown in FIG. 1, the user 101A may provide an input through a user interface 106-3A of user communications device 106A whereby the user 101A requests that the carrier/service provider server 100 modify (e.g. alter, add, remove, replace and/or view user data 105A, recipient data 105B, or user data 105A and recipient data 105B) a pre-existing illusory user identification characteristic maintained in memory 104. The ID management logic 103-1 may store the modified illusory user identification characteristic may be stored in memory 104 (e.g. stored as user data 105A, recipient data 105B, or user data 105A). The modified illusory user identification characteristic may overwrite the pre-existing illusory user identification characteristic or be stored to a separate memory location so as to preserve the pre-existing illusory user identification characteristic for future retrieval.

Operation 3406 depicts storing one or more non-illusory user identification characteristics associated with the one or more users. For example, as shown in FIG. 1, the user 101A may provide an input through a user interface 106-3A of user communications device 106A whereby the user 101A requests that the carrier/service provider server 100 create and/or modify non-illusory ID data 105-1A and/or non-illusory ID data 105-1B (e.g. a non-illusory user name). The communications data transceiver module 102 of the carrier/service provider server 100 may receive data 110A including the request. The ID management logic 103-1 may store one or more non-illusory user identification characteristics associated with the one or more users in the memory 104 according to the request by the user 101A.

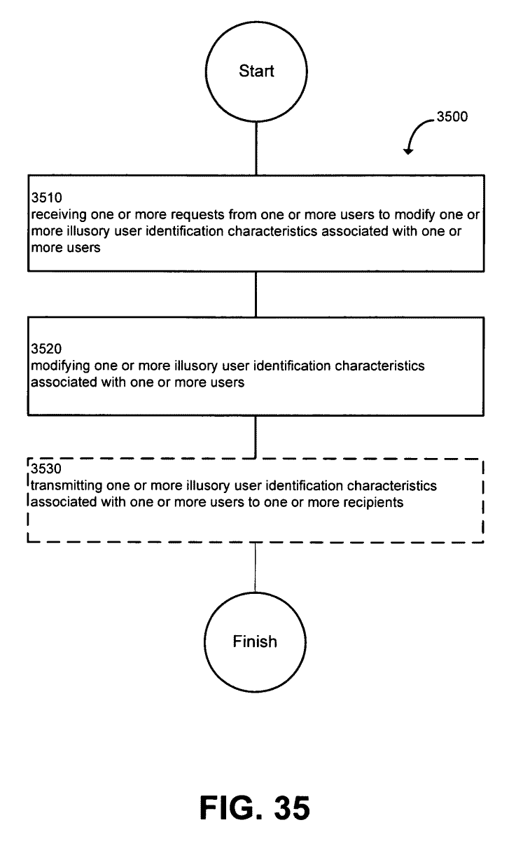

FIG. 35 illustrates an operational flow 3500 representing example operations related to transmitting illusory user identification characteristics. Operations 3510 and 3520 of operational flow 3500 may be similar to those of operations 2210 and 2220 respectively, as described above with respect to operational flow 2200. Operational flow 3500 may include one or more additional operations. Additional operations may include an operation 3530.

After a start operation, the operational flow 3500 moves to an operation 3510. The operation 3510 illustrates receiving one or more requests from one or more users to modify the one or more illusory user identification characteristics associated with the one or more users. For example, as shown in FIG. 1, the user 101A may provide an input through a user interface 106-3A of user communications device 106A whereby the user 101A requests that the carrier/service provider server 100 provide an access portal (e.g. a web interface, touch tone phone interface, a voice recognition interface, a graphical user interface, and the like) so as to modify ID database 105 (e.g. alter, add, remove, replace and/or view user data 105A, recipient data 105B, or user data 105A and recipient data 105B). The communications data transceiver module 102 of the carrier/service provider server 100 may receive data 110A including a request by the user 101A made from a user communications device 106A to modify ID database 105 maintained in memory 104.

The operation 3520 illustrates modifying one or more illusory user identification characteristics associated with the one or more users. For example, as shown in FIG. 1, the communications data transceiver module 102 of carrier/service provider server 100 may receive a request from user 101A to modify the ID database 105 (e.g. a request to alter a user name, image, voice signature, and the like). The database modification logic 103-5 of the carrier/service provider server 100 may modify the user data 105A, recipient data 105B, or user data 105A and recipient data 105B as requested by the user 101A by overwriting and/or remapping the user data 105A, recipient data 105B, or user data 105A and recipient data 105B to correspond to data representing the modified user characteristic (e.g. an updated voice signature having a lower pitch than the actual voice signature of user 101A).

Operation 3530 depicts transmitting one or more illusory user identification characteristics associated with one or more users to one or more recipients. For example, as shown in FIG. 1, the communications data transceiver module 102 of the carrier/service provider server 100 may transmit data 110B including illusory ID data 105-2A associated with user 101A to a recipient communications device 106B associated with a recipient 101B. The illusory ID data 105-2A may be received by a communications module 106-2B of the recipient communications device 106B and presented to the recipient 101B via the user interface 106-3B of the recipient communications device 106B. The communications data transceiver module 102 may transmit data 110B in any number of communications data formats including, but not limited to a voice call (e.g. a landline or wireless phone call), a text message, an instant message, an e-mail or a VoIP call.

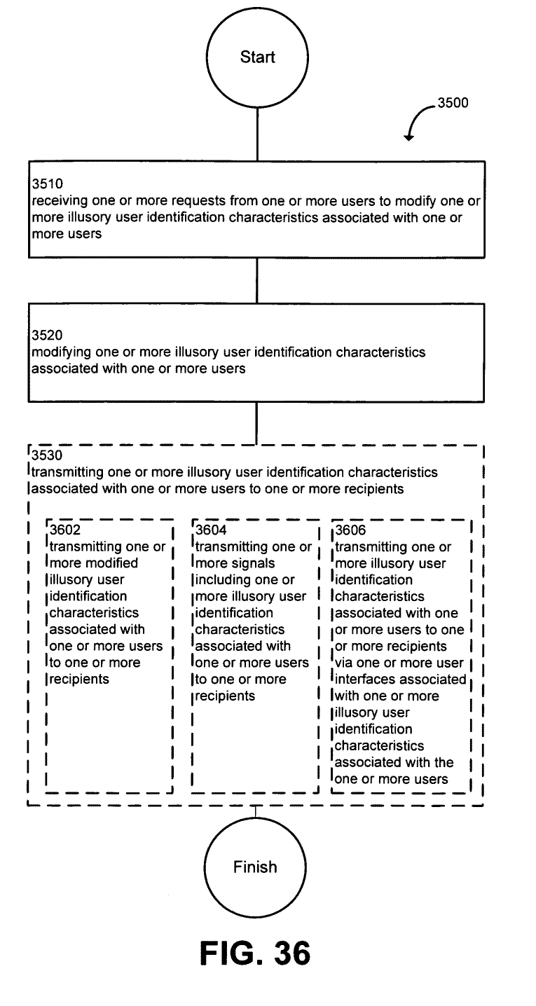

FIG. 36 illustrates alternative embodiments of the example operational flow 3500 of FIG. 35. FIG. 36 illustrates example embodiments where the operation 3530 may include at least one additional operation. Additional operations may include an operation 3602, an operation 3604, and/or an operation 3606.

Operation 3602 depicts transmitting one or more modified illusory user identification characteristics associated with one or more users to one or more recipients. For example, as shown in FIG. 1, the communications data transceiver module 102 of carrier/service provider server 100 may receive a request from user 101A to modify the ID database 105. The database modification logic 103-5 may modify (e.g. alter, add, remove, replace and/or display) illusory ID data 105-2A in response to the request from the user 101A. Following a modification of illusory ID data 105-2A, the communications data transceiver module 102 of the carrier/service provider server 100 may transmit data 110B including modified illusory ID data 105-2A associated with user 101A to a recipient communications device 106B associated with recipient 101B.

The operation 3604 illustrates transmitting one or more signals including the one or more illusory user identification characteristics associated with one or more users to one or more recipients. For example, as shown in FIG. 1, the communications data transceiver module 102 of the carrier/service provider server 100 may transmit data 110B including signals (e.g. electrical signals, radio frequency signals, and the like) including illusory ID data 105-2A associated with user 101A to a recipient communications device 106B associated with recipient 101B. The signals including the illusory ID data 105-2A may be received by a communications module 106-2B of the recipient communications device 106B and presented to the recipient 101B as one or more sounds, images, and the like, via the user interface 106-3B of the recipient communications device 106B. The communications data transceiver module 102 may transmit signal data 110B for any number of communication purposes including, but not limited to voice calls (e.g. a landline or wireless phone call), a text messages, an e-mails or a VoIP calls.

The operation 3606 illustrates transmitting one or more illusory user identification characteristics associated with one or more users to one or more recipients via one or more user interfaces associated with the one or more illusory user identification characteristics associated with one or more users. For example, as shown in FIG. 1, the communications data transceiver module 102 of the carrier/service provider server 100 may transmit data 110B including illusory ID data 105-2A associated with user 101A to a recipient communications device 106B associated with recipient 101B. The data 110B may further include user interface instructions which may cause recipient communications device 106B to present a particular user interface 106-3B to recipient 101B according to the illusory ID data 105-2A. The user interface 106-3B may include various displayed images and/or tones, user input options, and the like, which are associated with illusory ID data 105-2A. For example, when illusory ID data 105-2A is transmitted to recipient 101B, a password prompt may be provided to the recipient 101B. Alternately, when illusory ID data 105-2A′ is transmitted to recipient 101B, no prompt may be provided to the recipient 101B.

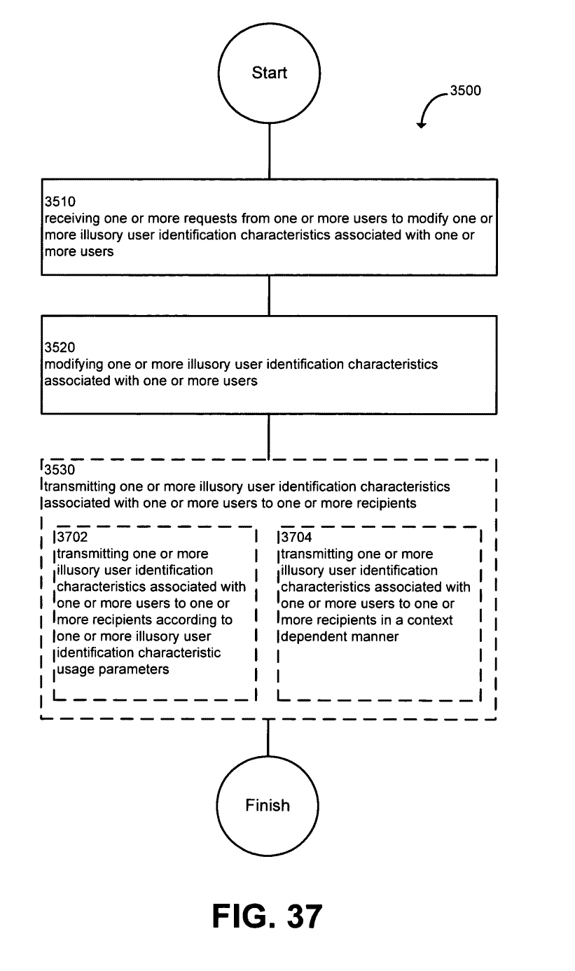

FIG. 37 illustrates alternative embodiments of the example operational flow 3500 of FIG. 35. FIG. 37 illustrates example embodiments where the operation 3530 may include at least one additional operation. Additional operations may include an operation 3702 and/or an operation 3704.

The operation 3702 illustrates transmitting one or more illusory user identification characteristics associated with one or more users to one or more recipients according to one or more illusory user identification characteristic usage parameters. For example, as shown in FIG. 1, the communications data transceiver module 102 of the carrier/service provider server 100 may transmit data 110B including illusory ID data 105-2A associated with user 101A to a recipient communications device 106B associated with recipient 101B according to an illusory user identification characteristic usage parameter (e.g. a location parameter, a time parameter, a proximity parameter). An illusory user identification characteristic usage parameter may control the manner in which the illusory ID data 105-2A is provided to recipient 101B (e.g. the illusory ID data 105-2A may only be transmitted to recipient 101B at certain times of the day while non-illusory ID data 105-1 may be transmitted to recipient 101B at other times of the day).

The operation 3704 illustrates transmitting one or more illusory user identification characteristics associated with one or more users to one or more recipients in a context dependent manner. For example, as shown in FIG. 1, the communications data transceiver module 102 of the carrier/service provider server 100 may transmit data 110B including illusory ID data 105-2A associated with user 101A to a recipient communications device 106B associated with recipient 101B according to a context (e.g. a location of user 101A, a location of the recipient 101B, a proximity of a third party 101C to user 101A and/or the recipient 101B, and the like) of the user 101A.

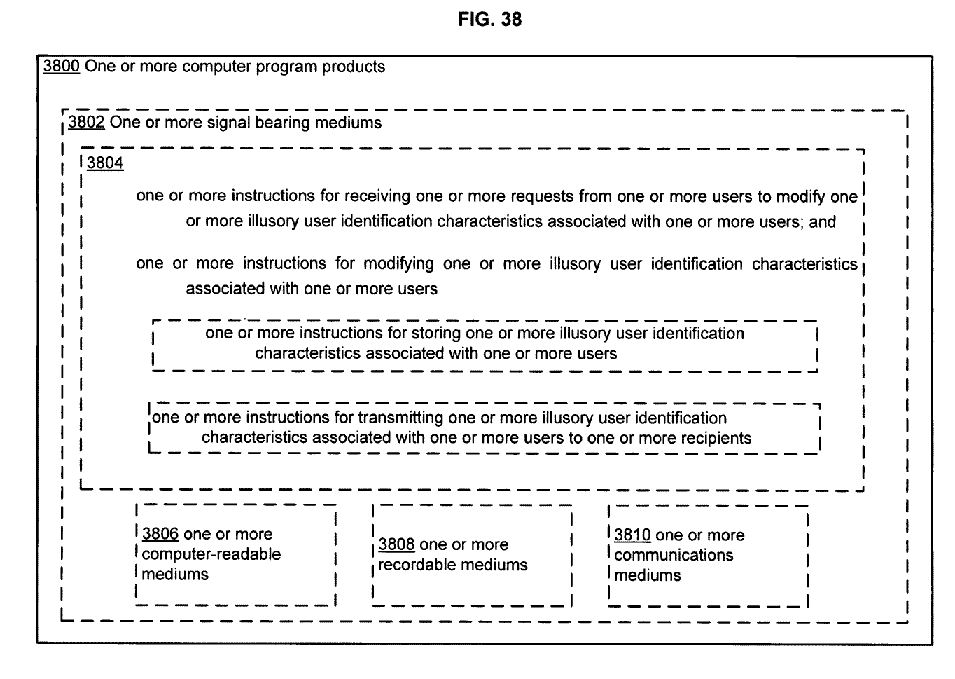

FIG. 38 illustrates a partial view of an example computer program product 3800 that includes a computer program 3804 for executing a computer process on a computing device. An embodiment of the example computer program product 3800 is provided using a signal-bearing medium 3802, and may include one or more instructions for receiving one or more requests from one or more users to modify the one or more illusory user identification characteristics associated with the one or more users; and one or more instructions for modifying one or more illusory user identification characteristics associated with the one or more users. The one or more instructions may be, for example, computer executable and/or logic-implemented instructions. In one implementation, the signal-bearing medium 3802 may include a computer-readable medium 3806. In one implementation, the signal bearing medium 3802 may include a recordable medium 3808. In one implementation, the signal bearing medium 3802 may include a communications medium 3810.

The computer program product 3800 may include one or more instructions for storing one or more illusory user identification characteristics associated with the one or more users.

The computer program product 3800 may include one or more instructions for transmitting one or more illusory user identification characteristics associated with one or more users to one or more recipients.

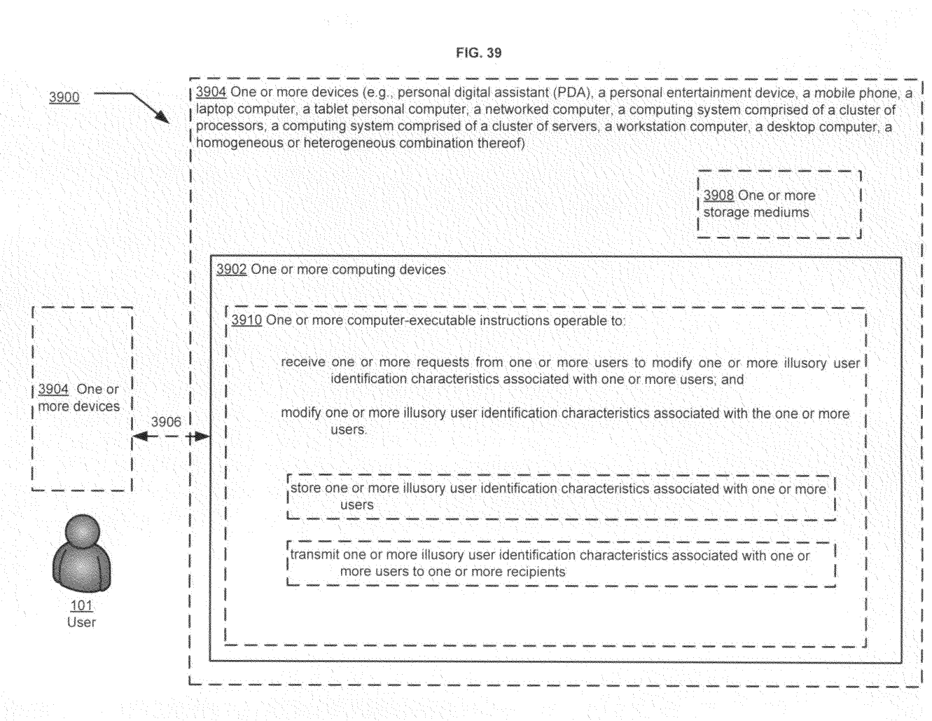

FIG. 39 illustrates an example system 3900 in which embodiments may be implemented. The system 3900 includes a computing system environment. The system 3900 also illustrates a user 101 using a device 3904, which is optionally shown as being in communication with a computing device 3902 by way of an optional coupling 3906. The optional coupling 3906 may represent a local, wide-area, or peer-to-peer network, or may represent a bus that is internal to a computing device (e.g., in example embodiments in which the computing device 3902 is contained in whole or in part within the device 3904). A storage medium 3908 may be any computer storage media.

The computing device 3902 includes computer-executable instructions 3910 that when executed on the computing device 3902 cause the computing device 3902 to receive one or more requests from one or more users to modify one or more illusory user identification characteristics associated with one or more users; and modify one or more illusory user identification characteristics associated with the one or more users. As referenced above and as shown in FIG. 39, in some examples, the computing device 3902 may optionally be contained in whole or in part within the device 3904.

The computing device 3902 may include computer-executable instructions 3910 that when executed on the computing device 3902 cause the computing device 3902 to store one or more illusory user identification characteristics associated with one or more users to one or more recipients.

The computing device 3902 may include computer-executable instructions 3910 that when executed on the computing device 3902 cause the computing device 3902 to transmit one or more illusory user identification characteristics associated with one or more users to one or more recipients.

In FIG. 39, the system 3900 includes at least one computing device (e.g., 3902 and/or 3904). The computer-executable instructions 3910 may be executed on one or more of the at least one computing device. For example, the computing device 3902 may implement the computer-executable instructions 3910 and output a result to (and/or receive data from) the computing device 3902. Since the computing device 3902 may be wholly or partially contained within the device 3904, the device 3904 also may be said to execute some or all of the computer-executable instructions 3910, in order to be caused to perform or implement, for example, various ones of the techniques described herein, or other techniques.

The device 3904 may include, for example, a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer. In another example embodiment, the computing device 3902 is operable to communicate with the device 3904 associated with the user 101 to receive information about the input from the user 101 for performing data access and data processing and presenting an output of the user-health test function at least partly based on the user data.

Further, the device 3904 may include a heterogeneous computing network including two or more of a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer, operably coupled to a common computing network.

Although a user 101 is shown/described herein as a single illustrated figure, those skilled in the art will appreciate that a user 101 may be representative of a human user, a robotic user (e.g., computational entity), and/or substantially any combination thereof (e.g., a user may be assisted by one or more robotic agents). In addition, a user 101, as set forth herein, although shown as a single entity may in fact be composed of two or more entities. Those skilled in the art will appreciate that, in general, the same may be said of “sender” and/or other entity-oriented terms as such terms are used herein.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/ implemented/translated/converted into high-level descriptor languages (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, transceiver, transmission logic, reception logic, etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include all possible multiple dependencies.

1. A method comprising:
transmitting one or more illusory user identification characteristics associated with one or more users to one or more recipients; and
receiving one or more requests from one or more users to modify the one or more illusory user identification characteristics associated with the one or more users.

2-36. (canceled)

37. A system comprising:
means for transmitting one or more illusory user identification characteristics associated with one or more users to one or more recipients;
means for receiving one or more requests from one or more users to modify the one or more illusory user identification characteristics associated with the one or more users.

38. The system of claim 37, wherein the means for transmitting one or more illusory user identification characteristics associated with one or more users to one or more recipients comprises:
means for transmitting one or more signals including the one or more illusory user identification characteristics associated with one or more users to one or more recipients.

39. The system of claim 37, wherein the means for transmitting one or more illusory user identification characteristics associated with one or more users to one or more recipients comprises:
means for transmitting one or more illusory user identification characteristics associated with one or more users to one or more recipients via one or more user interfaces associated with the one or more illusory user identification characteristics associated with one or more users.

40. The system of claim 37, wherein the means for transmitting one or more illusory user identification characteristics associated with one or more users to one or more recipients comprises:
means for transmitting one or more illusory user identification characteristics associated with one or more users to one or more recipients according to one or more illusory user identification characteristic usage parameters.

41. The system of claim 37, wherein the means for transmitting one or more illusory user identification characteristics associated with one or more users to one or more recipients comprises:
means for transmitting one or more illusory user identification characteristics associated with one or more users to one or more recipients in a context dependent manner.

42-46. (canceled)

47. The system of claim 37, further comprising:
means for modifying one or more illusory user identification characteristics associated with the one or more users

48. The system of claim 47, wherein the means for modifying one or more illusory user identification characteristics associated with the one or more users comprises:
means for modifying one or more non-illusory user identification characteristics associated with the one or more users.

49. The system of claim 47, wherein the means for modifying one or more illusory user identification characteristics associated with the one or more users comprises:
means for modifying one or more illusory user identification characteristics associated with the one or more users according to one or more identity authentications of the one or more users.

50. The system of claim 49, wherein the means for modifying one or more illusory user identification characteristics associated with the one or more users according to one or more identity authentications of the one or more users comprises:
means for modifying one or more illusory user identification characteristics associated with the one or more users according to one or more password identity authentications of the one or more users.

51. The system of claim 49, wherein the means for modifying one or more illusory user identification characteristics associated with the one or more users according to one or more identity authentications of the one or more users comprises:
means for modifying one or more illusory user identification characteristics associated with one or more users according to one or more biometric identity authentications of the one or more users.

52. The system of claim 49, wherein the means for modifying one or more illusory user identification characteristics associated with the one or more users according to one or more identity authentications of the one or more users comprises:
means for modifying one or more illusory user identification characteristics associated with one or more users according to one or more fingerprint identity authentications of the one or more users.

53. The system of claim 49, wherein the means for modifying one or more illusory user identification characteristics associated with the one or more users according to one or more identity authentications of the one or more users comprises:
means for modifying one or more illusory user identification characteristics associated with one or more users according to one or more voice identity authentications of the one or more users.

54. The system of claim 49, wherein the means for modifying one or more illusory user identification characteristics associated with the one or more users according to one or more identity authentications of the one or more users comprises:
means for modifying one or more illusory user identification characteristics associated with one or more users according to one or more retinal scan identity authentications of the one or more users.

55. The system of claim 49, wherein the means for modifying one or more illusory user identification characteristics associated with the one or more users according to one or more identity authentications of the one or more users comprises:
means for modifying one or more illusory user identification characteristics associated with one or more users according to one or more cryptographic identity authentications of the one or more users.

56. The system of claim 47, wherein the means for modifying one or more illusory user identification characteristics associated with the one or more users comprises:
means for modifying one or more illusory user identification characteristics associated with the one or more users in a context dependent manner.

57. The system of claim 56, wherein the means for modifying one or more illusory user identification characteristics associated with the one or more users in a context dependent manner comprises:
means for modifying one or more illusory user identification characteristics associated with the one or more users in a manner dependent upon one or more locations of one or more transceivers associated with the one or more users.

58. The system of claim 56, wherein the means for modifying one or more illusory user identification characteristics associated with the one or more users in a context dependent manner comprises:
means for modifying one or more illusory user identification characteristics associated with the one or more users in a manner dependent upon global positioning system (GPS) data associated with one or more electronic devices.

59. The system of claim 56, wherein the means for modifying one or more illusory user identification characteristics associated with the one or more users in a context dependent manner comprises:
means for modifying one or more illusory user identification characteristics associated with the one or more users in a manner dependent upon one or more locations of one or more identified devices associated with the one or more users.

60. The system of claim 56, wherein the means for modifying one or more illusory user identification characteristics associated with the one or more users in a context dependent manner comprises:
means for modifying one or more illusory user identification characteristics associated with the one or more users in response to one or more electromagnetic signals associated with one or more electronic devices in one or more regions proximate to the one or more users.

61. The system of claim 56, wherein the means for modifying one or more illusory user identification characteristics associated with the one or more users in a context dependent manner comprises:
means for modifying one or more illusory user identification characteristics associated with the one or more users in response to image data associated with one or more regions proximate to the one or more users.

62. The system of claim 56, wherein the means for modifying one or more illusory user identification characteristics associated with the one or more users in a context dependent manner comprises:
means for modifying one or more illusory user identification characteristics associated with the one or more users in response to audio signal data associated with one or more regions proximate to the one or more users.

63. The system of claim 56, wherein the means for modifying one or more illusory user identification characteristics associated with the one or more users in a context dependent manner comprises:
means for modifying one or more illusory user identification characteristics associated with the one or more users in a manner dependent on one or more times of day.

64. The system of claim 37, further comprising:
means for storing one or more illusory user identification characteristics associated with the one or more users.

65. The system of claim 64, wherein the means for storing one or more illusory user identification characteristics associated with the one or more users further comprises:
means for storing one or more unmodified illusory user identification characteristics associated with the one or more users.

66. The system of claim 64, wherein the means for storing one or more illusory user identification characteristics associated with the one or more users further comprises:
means for storing one or more modified illusory user identification characteristics associated with the one or more users.

67. The system of claim 64, wherein the means for storing one or more illusory user identification characteristics associated with the one or more users further comprises:
means for storing one or more non-illusory user identification characteristics associated with the one or more users.

68. The system of claim 37, further comprising:
means for transmitting one or more modified illusory user identification characteristics associated with one or more users to one or more recipients.

69. The system of claim 68, wherein the means for means for transmitting one or more modified illusory user identification characteristics associated with one or more users to one or more recipients comprises:
means for transmitting one or more signals including one or more modified illusory user identification characteristics associated with one or more users to one or more recipients.

70. The system of claim 68, wherein the means for means for transmitting one or more modified illusory user identification characteristics associated with one or more users to one or more recipients comprises:
means for transmitting one or more modified illusory user identification characteristics associated with one or more users to one or more recipients via one or more user interfaces associated with one or more modified illusory user identification characteristics associated with the one or more users.

71. The system of claim 68, wherein the means for means for transmitting one or more modified illusory user identification characteristics associated with one or more users to one or more recipients comprises:
means for transmitting one or more modified illusory user identification characteristics associated with one or more users to one or more recipients according to one or more illusory user identification characteristic usage parameters.

72. The system of claim 68, wherein the means for transmitting one or more modified illusory user identification characteristics associated with one or more users to one or more recipients comprises:
means for transmitting one or more modified illusory user identification characteristics associated with one or more users to one or more recipients in a context dependent manner.

73-94. (canceled)

95. A method comprising:
receiving one or more requests from one or more users to modify one or more illusory user identification characteristics associated with one or more users; and
modifying one or more illusory user identification characteristics associated with the one or more users.

96-126. (canceled)

127. A system comprising:
means for receiving one or more requests from one or more users to modify one or more illusory user identification characteristics associated with one or more users; and
means for modifying one or more illusory user identification characteristics associated with the one or more users.

128-132. (canceled)

133. The system of claim 127, wherein the means for modifying one or more illusory user identification characteristics associated with the one or more users comprises:
means for modifying one or more non-illusory user identification characteristics associated with the one or more users.

134. The system of claim 127, wherein the means for modifying one or more illusory user identification characteristics associated with the one or more users comprises:
means for modifying one or more illusory user identification characteristics associated with the one or more users according to one or more identity authentications of the one or more users.

135. The system of claim 134, wherein the means for modifying one or more illusory user identification characteristics associated with the one or more users according to one or more identity authentications of the one or more users comprises:
means for modifying one or more illusory user identification characteristics associated with the one or more users according to one or more password identity authentications of the one or more users.

136. The system of claim 134, wherein the means for modifying one or more illusory user identification characteristics associated with the one or more users according to one or more identity authentications of the one or more users comprises:
means for modifying one or more illusory user identification characteristics associated with one or more users according to one or more biometric identity authentications of the one or more users.

137. The system of claim 134, wherein the means for modifying one or more illusory user identification characteristics associated with the one or more users according to one or more identity authentications of the one or more users comprises:
means for modifying one or more illusory user identification characteristics associated with one or more users according to one or more fingerprint identity authentications of the one or more users.

138. The system of claim 134, wherein the means for modifying one or more illusory user identification characteristics associated with the one or more users according to one or more identity authentications of the one or more users comprises:
means for modifying one or more illusory user identification characteristics associated with one or more users according to one or more voice identity authentications of the one or more users.

139. The system of claim 134, wherein the means for modifying one or more illusory user identification characteristics associated with the one or more users according to one or more identity authentications of the one or more users comprises:
means for modifying one or more illusory user identification characteristics associated with one or more users according to one or more retinal scan identity authentications of the one or more users.

140. The system of claim 134, wherein the means for modifying one or more illusory user identification characteristics associated with the one or more users according to one or more identity authentications of the one or more users comprises:
means for modifying one or more illusory user identification characteristics associated with one or more users according to one or more cryptographic identity authentications of the one or more users.

141. The system of claim 127, wherein the means for modifying one or more illusory user identification characteristics associated with the one or more users comprises:
means for modifying one or more illusory user identification characteristics associated with the one or more users in a context dependent manner.

142. The system of claim 141, wherein the means for modifying one or more illusory user identification characteristics associated with the one or more users in a context dependent manner comprises:
means for modifying one or more illusory user identification characteristics associated with the one or more users in a manner dependent upon one or more locations of one or more transceivers associated with the one or more users.

143. The system of claim 141, wherein the means for modifying one or more illusory user identification characteristics associated with the one or more users in a context dependent manner comprises:
means for modifying one or more illusory user identification characteristics associated with the one or more users in a manner dependent upon global positioning system (GPS) data associated with one or more electronic devices.

144. The system of claim 141, wherein the means for modifying one or more illusory user identification characteristics associated with the one or more users in a context dependent manner comprises:
means for modifying one or more illusory user identification characteristics associated with the one or more users in a manner dependent upon one or more locations of one or more identified devices associated with the one or more users.

145. The system of claim 141, wherein the means for modifying one or more illusory user identification characteristics associated with the one or more users in a context dependent manner comprises:
means for modifying one or more illusory user identification characteristics associated with the one or more users in response to one or more electromagnetic signals associated with one or more electronic devices in one or more regions proximate to the one or more users.

146. The system of claim 141, wherein the means for modifying one or more illusory user identification characteristics associated with the one or more users in a context dependent manner comprises:
means for modifying one or more illusory user identification characteristics associated with the one or more users in response to image data associated with one or more regions proximate to the one or more users.

147. The system of claim 141, wherein the means for modifying one or more illusory user identification characteristics associated with the one or more users in a context dependent manner comprises:
means for modifying one or more illusory user identification characteristics associated with the one or more users in response to audio signal data associated with one or more regions proximate to the one or more users.

148. The system of claim 141, wherein the means for modifying one or more illusory user identification characteristics associated with the one or more users in a context dependent manner comprises:
means for modifying one or more illusory user identification characteristics associated with the one or more users in a manner dependent on one or more times of day.

149. The system of claim 127, further comprising:
means for storing one or more illusory user identification characteristics associated with the one or more users.

150. The system of claim 149, wherein the means for storing one or more illusory user identification characteristics associated with the one or more users further comprises:
means for storing one or more unmodified illusory user identification characteristics associated with the one or more users.

151. The system of claim 149, wherein the means for storing one or more illusory user identification characteristics associated with the one or more users further comprises:
means for storing one or more modified illusory user identification characteristics associated with the one or more users.

152. The system of claim 149, wherein the means for storing one or more illusory user identification characteristics associated with the one or more users further comprises:
means for storing one or more non-illusory user identification characteristics associated with the one or more users.

153. The system of claim 127, further comprising:
means for transmitting one or more illusory user identification characteristics associated with one or more users to one or more recipients.

154. The system of claim 153, wherein the means for transmitting one or more illusory user identification characteristics associated with one or more users to one or more recipients comprises:
means for transmitting one or more modified illusory user identification characteristics associated with one or more users to one or more recipients.

155. The system of claim 153, wherein the means for transmitting one or more illusory user identification characteristics associated with one or more users to one or more recipients comprises:
means for transmitting one or more signals including the one or more illusory user identification characteristics associated with one or more users to one or more recipients.

156. The system of claim 153, wherein the means for transmitting one or more illusory user identification characteristics associated with one or more users to one or more recipients comprises:
means for transmitting one or more illusory user identification characteristics associated with one or more users to one or more recipients via one or more user interfaces associated with the one or more illusory user identification characteristics associated with one or more users.

157. The system of claim 153, wherein the means for transmitting one or more illusory user identification characteristics associated with one or more users to one or more recipients comprises:
means for transmitting one or more illusory user identification characteristics associated with one or more users to one or more recipients according to one or more illusory user identification characteristic usage parameters.

158. The system of claim 153, wherein the means for transmitting one or more illusory user identification characteristics associated with one or more users to one or more recipients comprises:
means for transmitting one or more illusory user identification characteristics associated with one or more users to one or more recipients in a context dependent manner.

159-176. (canceled)
